(19) United States
(12) Patent Application Publication
(10) Pub. No.: US 2021/0395965 A1
(43) Pub. Date: Dec. 23, 2021

(54) Decorative Sheet for Road Surface, Precursor For Graphic Construct, Method of Producing Graphic Construct Sheet, And Method of Installing Decorative Sheet for Road Surface

(71) Applicant: 3M INNOVATIVE PROPERTIES COMPANY, St. Paul, MN (US)

(72) Inventors: Yoshinori Araki, Yamagata (JP); Hidetoshi Abe, Yamagata (JP); Takeshi Dobashi, Tokyo (JP); Junichi Saito, Yamagata (JP); Ken Okura, Tokyo (JP); Masaaki Furusawa, Yamagata (JP)

(21) Appl. No.: 16/967,811

(22) PCT Filed: Feb. 5, 2019
(86) PCT No.: PCT/IB2019/050919

§ 371 Date: Aug. 6, 2020

(30) Foreign Application Priority Data
Feb. 6, 2018 (JP) 2018-019450
Oct. 5, 2018 (JP) 2018-190334

(51) Int. Cl. E01F 9/512; B41J 3/407

(52) U.S. Cl. CPC E01F 9/512; B41J 3/407

(57) ABSTRACT

Object: To provide a decorative sheet for a road surface having enhanced surface strength with respect to a large vehicle weight of a vehicle and having enhanced stationary steering resistance against a steering operation performed while a vehicle is stopped. Solution: A decorative sheet for a road surface according to an embodiment of the present invention includes: a graphic construct including an adhesive layer, and a design layer provided on the adhesive layer; and a surface coating layer covering the graphic construct and containing a urethane resin.

### TECHNICAL FIELD

The present invention relates to a decorative sheet for a road surface to be attached to a road surface, a precursor for a graphic construct, a method of producing a graphic construct sheet, and a method of installing a decorative sheet for a road surface.

### BACKGROUND ART

There is known a decorative sheet for a floor surface or a road surface on which colors, patterns, or characters are applied. To maintain visibility of characters, figures, or the like depicted on a decorative sheet for a long period of time, a film containing a material such as an ultraviolet light curing resin is sometimes provided on the decorative sheet. For example, Patent Literature 1 discloses a method including forming a coating film of an ultraviolet light curing paint on a seal on which an image is printed, and curing the coating film with an ultraviolet light irradiation device.

### CITATION LIST

### Patent Literature

Patent Literature 1: JP 2006-161525 A

### SUMMARY OF INVENTION

### Technical Problem

Vehicles such as automobiles travel over road surfaces, and vehicles include automobiles having large vehicle weights such as large trucks. In addition, depending on the vehicles, a driver sometimes performs a steering operation, that is, stationary steering over a decorative sheet while the vehicle is stopped. Namely, in the case of the above-described decorative sheet applied on a road surface, there is a possibility that the decorative sheet may be damaged by tires of a vehicle, and indentations or distortions are formed and that visibility of characters, figures, or the like may decrease. Accordingly, there is a demand for a decorative sheet used for a road surface to have surface strength with respect to a large vehicle weight of a vehicle and stationary steering resistance against a steering operation performed while a vehicle is stopped.

### Solution to Problem

A decorative sheet according to a mode of the present invention includes: a graphic construct including an adhesive layer, and a design layer provided on the adhesive layer; and a surface coating layer covering the graphic construct and containing a urethane resin. In addition, a method of installing a decorative sheet for a road surface according to another mode of the present invention includes: installing a graphic construct including an adhesive layer and a design layer provided on the adhesive layer on a road surface; and coating a surface of the graphic construct installed on the road surface with a urethane resin.

### Advantageous Effects of Invention

According to an aspect of the present invention, it is possible to provide a decorative sheet for a road surface having enhanced surface strength with respect to a large vehicle weight of a vehicle and having enhanced stationary steering resistance against a steering operation performed while a vehicle is stopped. According to another aspect of the present invention, it is possible to provide a method of installing a decorative sheet for a road surface, enabling a decorative sheet for a road surface having enhanced road surface followability to be easily installed on a road surface.

### BRIEF DESCRIPTION OF DRAWINGS

FIG. 1 is a view schematically illustrating a cross section of a decorative sheet for a road surface according to an embodiment of the present invention.

FIG. 2 is a flowchart illustrating a method of installing the decorative sheet for a road surface according to the embodiment of the present invention.

FIG. 3 is a plan view illustrating the decorative sheet for a road surface installed on a road surface according to the embodiment of the present invention.

FIG. 4 is a view schematically illustrating a cross section of a decorative sheet for a road surface according to another embodiment of the present invention.

FIG. 5 is a view schematically illustrating a cross section of a decorative sheet for a road surface according to another embodiment of the present invention.

FIG. 6 is a view schematically illustrating a cross section of a decorative sheet for a road surface according to another embodiment of the present invention.

FIG. 7 is a view schematically illustrating a cross section of a decorative sheet for a road surface according to another embodiment of the present invention.

FIG. 8A, FIG. 8B, and FIG. 8C are views each schematically illustrating a cross section of a design layer including a retroreflective layer according to an embodiment of the present invention.

FIG. 9A is a view schematically illustrating a cross section of a precursor for a graphic construct according to an embodiment of the present invention. FIG. 9B is a view schematically illustrating a cross section of a printed precursor on which a design layer is formed according to an embodiment of the present invention. FIG. 9C is a view schematically illustrating a cross section of a graphic construct sheet according to an embodiment of the present invention.

FIG. 10 is a flowchart illustrating a method of producing a graphic construct sheet according to an embodiment of the present invention.

FIG. 11A shows results of measuring retroreflectivity performance according to Example 12, and FIG. 11B shows results of measuring retroreflectivity performance according to Example 13.

### DESCRIPTION OF EMBODIMENTS

A decorative sheet for a road surface according to an embodiment includes: a graphic construct including an adhesive layer, and a design layer provided on the adhesive layer; and a surface coating layer covering the graphic construct and containing a urethane resin.

According to this decorative sheet for a road surface, the decorative sheet for a road surface can be installed easily on a road surface with the adhesive layer, and a design such as characters and figures can also be applied easily with the design layer. Since the surface coating layer provided on the design layer contains a urethane resin, the surface coating layer has high mechanical strength and high torsional resistance. High surface strength is guaranteed by high mechanical strength, and high stationary steering resistance is guaranteed by high torsional resistance. As a result, this decorative sheet for a road surface can have enhanced surface strength with respect to a large vehicle weight of a vehicle and enhanced stationary steering resistance against a steering operation performed while a vehicle is stopped.

In the decorative sheet for a road surface according to another mode, the urethane resin may contain a two-part urethane resin composition including a polyol as a main agent and a polyfunctional isocyanate as a curing agent. According to this decorative sheet for a road surface, the urethane resin imparts higher mechanical strength and high torsional resistance. This decorative sheet for a road surface can have further enhanced surface strength with respect to a large vehicle weight of a vehicle and further enhanced stationary steering resistance against a steering operation performed while a vehicle is stopped.

In the decorative sheet for a road surface according to another mode, the surface coating layer may include an anti-skid member. According to this decorative sheet for a road surface, tires of a vehicle traveling over the decorative sheet for a road surface become difficult to skid.

In the decorative sheet for a road surface according to another mode, the design layer may include an ink absorbing layer and a supporting layer configured to support the ink absorbing layer, and the ink absorbing layer may be provided on the supporting layer. Since this decorative sheet for a road surface includes the ink absorbing layer, characters, figures, or the like can be depicted in detail on the ink absorbing layer. In addition, indentations or protrusions on a road surface are absorbed by the supporting layer configured to support the ink absorbing layer, and deformation of characters, figures, or the like depicted on the ink absorbing layer is reduced.

In the decorative sheet for a road surface according to another mode, the supporting layer may include aluminum foil. According to this decorative sheet for a road surface, the supporting layer further absorbs indentations or protrusions on a road surface, and deformation of characters, figures, or the like depicted on the ink absorbing layer is reduced.

The decorative sheet for a road surface according to another mode may further include a retroreflective member on a top end portion of the surface coating layer. According to this decorative sheet for a road surface, the retroreflective member provided on the top end portion of the surface coating layer and exposed from the surface coating enhances visibility of the decorative sheet for a road surface to a driver or the like of an automobile.

In the decorative sheet for a road surface according to another mode, the retroreflective member may contain glass beads. According to this decorative sheet for a road surface, since the retroreflective member contains glass beads, the retroreflective member becomes less likely to be affected by changes in an incident direction of external light in retroreflection, and visibility of the decorative sheet for a road surface to a driver or the like of an automobile is further enhanced.

In the decorative sheet for a road surface according to another mode, the design layer may further include an ink absorbing layer and a retroreflective layer, and the retroreflective layer may be disposed between the ink absorbing layer and the adhesive layer. According to this decorative sheet for a road surface, since the retroreflective layer may be provided between the ink absorbing layer and the adhesive layer, namely, beneath the design layer, external light incident inside the decorative sheet for a road surface can pass through the ink absorbing layer of the design layer, and then can be reflected by the retroreflective layer to pass through the ink absorbing layer again. As a result, visibility of characters, figures, or the like applied on the ink absorbing layer of the design layer to a driver or the like of an automobile is even more enhanced.

In the decorative sheet for a road surface according to another mode, the retroreflective layer may include an intermediate resin layer containing a resin surrounding a retroreflective member, and a reflective vapor deposited layer covering the intermediate resin layer, and the reflective vapor deposited layer may be disposed between the intermediate resin layer and the adhesive layer. According to this decorative sheet for a road surface, since the reflective vapor deposited layer may be disposed between the intermediate resin layer and the adhesive layer, external light incident inside the decorative sheet for a road surface can pass through the ink absorbing layer and the intermediate resin layer, and then can be reflected by the reflective vapor deposited layer to pass through the intermediate resin layer and the ink absorbing layer again. The retroreflective member of the retroreflective layer is surrounded by the resin in the intermediate resin layer and thus can be held stably.

In the decorative sheet for a road surface according to another mode, the retroreflective member of the retroreflective layer may contain glass beads. According to this decorative sheet for a road surface, since the retroreflective member contains glass beads, the retroreflective member becomes less likely to be affected by changes in an incident direction of external light in retroreflection, and visibility of the decorative sheet for a road surface to a driver or the like of an automobile is further enhanced.

In the decorative sheet for a road surface according to another mode, the design layer may further include a supporting layer configured to support the retroreflective layer and disposed between the retroreflective layer and the adhesive layer. According to this decorative sheet for a road surface, the supporting layer further absorbs indentations or protrusions on a road surface, and deformation of the retroreflective layer is reduced.

A precursor for a graphic construct according to an embodiment includes a pre-design layer including an ink absorbing layer and a supporting layer, and a backing film layer including a substrate film layer and a pressure-sensitive adhesive layer, and the backing film layer is peelably attached to the pre-design layer with the pressure-sensitive adhesive layer.

According to this precursor for a graphic construct, since the precursor for a graphic construct includes the backing film layer, formation stability is high at the time of printing by an inkjet printer or the like, and characters, figures, or the like can be printed clearly on the pre-design layer. In addition, since the backing film layer can be peeled easily from the design layer produced by printing on the pre-design layer, the design layer can be installed easily on a road surface after the backing film layer is removed.

In the precursor for a graphic construct according to another mode, the precursor may have a stiffness exceeding 320 mgf, and the pressure-sensitive adhesive layer may have adhesive strength smaller than 0.5 N/25 mm.

According to this precursor for a graphic construct, since the precursor for a graphic construct has a stiffness exceeding 320 mgf, a shape of a sheet can be stable even at the time of printing, and the sheet can be transported smoothly. In addition, since the pressure-sensitive adhesive layer of the backing film layer has adhesive strength smaller than 0.5 N/25 mm, the backing film layer can be peeled easily from a printed precursor after characters, figures, or the like are printed on the pre-design layer, and the design layer can be installed easily on a road surface with the adhesive layer interposed between the design layer and the road surface, for example.

A method of producing a graphic construct sheet according to an embodiment includes the steps of: forming a design layer by using a precursor for a graphic construct including, in this order, at least an ink absorbing layer, a supporting layer, and a backing film layer including a pressure-sensitive adhesive layer to perform printing on the ink absorbing layer of the precursor; and peeling the backing film layer from a printed precursor on which the design layer is formed.

According to this method of producing a graphic construct sheet, the design layer can be formed by using the precursor for a graphic construct to perform printing on the ink absorbing layer by a printer in a factory, for example. After the formation of the design layer, the precursor obtained after the printing and including the design layer is transported to a road surface over which people or vehicles travel, and after the backing film layer is peeled from this precursor and the graphic construct sheet is removed, the graphic construct sheet can be installed easily on the road surface.

A method of installing a decorative sheet for a road surface according to an embodiment includes the steps of: installing a graphic construct including an adhesive layer and a design layer provided on the adhesive layer on a road surface; and coating a surface of the graphic construct installed on the road surface with a urethane resin.

According to this method of installing a decorative sheet for a road surface, since the graphic construct having flexibility is first installed on a road surface, and then is coated with a urethane resin having high coatability to form the decorative sheet, a decorative sheet for a road surface having improved road followability can be installed easily on the road surface.

In the decorative sheet for a road surface according to another mode, a region coated with the urethane resin in the step of coating with the urethane resin may include a road surface portion exposed without being covered with the graphic construct around a perimeter of the graphic construct.

According to this method of installing a decorative sheet for a road surface, since the surface coating layer widely covers not only the top of the graphic construct, but also the perimeter of the graphic construct including an end portion of the graphic construct, peeling of the decorative sheet for a road surface can be suppressed effectively.

In this specification, the “decorative sheet for a road surface” refers to a decorative sheet attached to a road surface of a road or a parking lot over which people or vehicles travel, and including a traffic sign, destination guidance, or the like depicted with characters, figures, or the like. The road surface is formed from typical materials for a road surface such as asphalt, concrete, and stone. The “surface coating layer” refers to a layer including a face exposed to a surface of the decorative sheet for a road surface formed by a coating method. People or vehicles travel over the surface coating layer. The “design layer” refers to a layer mainly for imparting a design including characters, figures, or the like to the decorative sheet for a road surface. In addition, the “adhesive layer” refers to a layer containing an adhesive to attach the decorative sheet for a road surface to a road surface. In addition, the “graphic construct” refers to a “decorative sheet for a road surface” prior to including a surface coating layer and refers to a construct including at least an adhesive layer and a design layer provided on the adhesive layer, and being an article that can be produced independently, and that can be used directly as a decorative sheet for a road surface. The “precursor for a graphic construct” refers to a sheet-like member used to form the design layer of a graphic construct. The precursor for a graphic construct is an article that can be produced independently. The “precursor” includes a pre-design layer, and the “pre-design layer” corresponds to a design layer being in a state prior to printing on the ink absorbing layer. The “backing film layer” refers to a layer peelably bonded to the pre-design layer to stabilize a shape of the pre-design layer at the time of printing of the pre-design layer, and peeled from the design layer after printing is complete. The “stiffness” of the precursor for a graphic construct refers to a value obtained by measurement in a Gurley stiffness test. Note that as a matter of convenience, to differentiate from the graphic construct, the construct obtained by peeling the backing film layer from the printed precursor, and substantially including only the design layer will be referred to as the “graphic construct sheet.” The graphic construct sheet is also an article that can be produced independently.

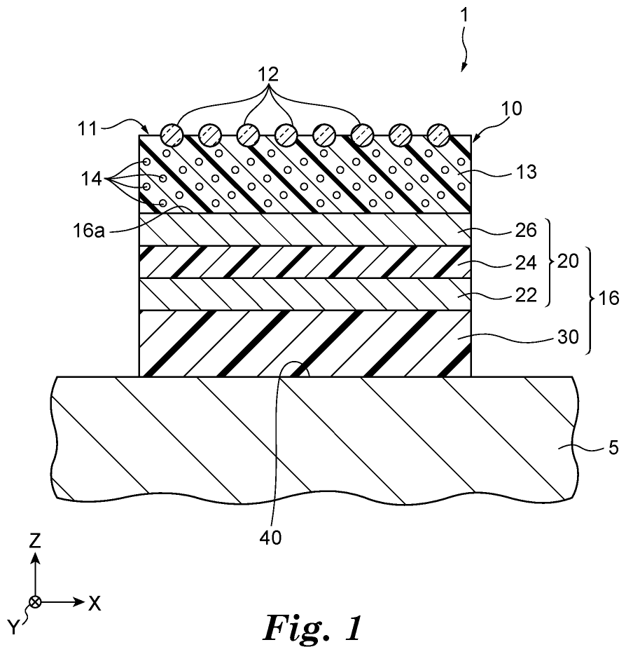

A decorative sheet for a road surface will be described in detail hereinafter with reference to the drawings. In this description, the same elements will be denoted by the same reference sings, and redundant description thereof will be omitted. In this embodiment, an X-axis, a Y-axis, and a Z-axis are set with respect to FIGS. 1 and 3 to 7, but each of these axes is set for the purpose of explanatory convenience, and the Z-axis is set in a lamination direction of the decorative sheet for a road surface.

FIG. 1 is view schematically illustrating a cross section of a decorative sheet for a road surface according to an embodiment. In FIG. 1, a decorative sheet 1 for a road surface attached onto a road surface 5 is depicted. The decorative sheet 1 for a road surface includes a surface coating layer 10, a design layer 20, and an adhesive layer 30. The design layer 20 is provided on the adhesive layer 30, and a graphic construct 16 includes the design layer 20 and the adhesive layer 30. The graphic construct 16 is covered with the surface coating layer 10. In this embodiment, the adhesive layer 30 is positioned at a lowest portion of the decorative sheet 1 for a road surface. In this embodiment, the “design layer 20 is provided on the adhesive layer 30” includes a case where the design layer 20 is provided on the adhesive layer 30 to be adjacent to the adhesive layer 30, and also includes a case where the design layer 20 is provided above the adhesive layer 30 to sandwich, for example, another layer between the design layer 20 and the adhesive layer 30.

The surface coating layer 10 includes a resin layer 13 containing a solvent-resistant crosslinking resin, in particular, a urethane resin. Various known urethane resins can be used as the urethane resin. The urethane resin can be obtained by drying or curing a urethane resin composition. The urethane resin composition may be an aqueous system, or may be a non-aqueous system. It is advantageous that the urethane resin is a cured product of a two-part urethane resin composition. The two-part urethane resin composition is typically a non-aqueous urethane resin composition. The two-part urethane resin composition typically contains a polyol as a main agent and a polyfunctional isocyanate as a curing agent.

As the polyol, a polyester polyol such as polycaprolactone diol and polycaprolactone triol; a polycarbonate polyol such as cyclohexanedimethanol carbonate and 1,6-hexanediol carbonate; and a combination of these can be used. These polyols can impart transparency, weather resistance, strength, chemical resistance, and the like to the surface coating layer. In particular, the polycarbonate polyol can form the surface coating layer having high transparency and chemical resistance.

Examples of the polyfunctional isocyanate include an aliphatic polyisocyanate, an alicyclic polyisocyanate, an aromatic polyisocyanate, and an aromatic aliphatic polyisocyanate, and multimers (dimers, trimers, and the like), biuret-modified products, allophanate-modified products, polyol-modified products, oxadiazine trione-modified products, and carbodiimide-modified products of these polyisocyanates. From the perspective of imparting stretchability to the surface coating layer without forming an excessive degree of crosslinked structure, the polyfunctional isocyanate is desirably diisocyanate. Examples of such diisocyanate include an aliphatic diisocyanate such as tetramethylene diisocyanate and hexamethylene diisocyanate (HDI); an alicyclic diisocyanate such as isophorone diisocyanate, trans,trans- and trans,cis- and cis,cis-dicyclohexylmethane-4,4′-diisocyanate and a mixture of these (hydrogenated MDI); an aromatic diisocyanate such as 2,4-tolylene diisocyanate and 2,6-tolylene diisocyanate, and an isomeric mixture of these tolylene diisocyanates (TDI), 4,4′-diphenylmethane diisocyanate, 2,4′-diphenylmethane diisocyanate, 2,2′-diphenylmethane diisocyanate, and an isomeric mixture of these diphenylmethane diisocyanates (MDI); and an aromatic aliphatic diisocyanate such as 1,3- or 1,4-xylylene diisocyanate or a mixture thereof (XDI), and 1,3- or 1,4-tetramethylxylylene diisocyanate or a mixture thereof (TMXDI).

As an equivalent weight ratio of the polyol to the polyisocyanate, typically, an equivalent weight of the polyisocyanate may be approximately 0.6 equivalents or greater, approximately 0.7 equivalents or greater, and approximately 2 equivalents or less, or approximately 1.2 equivalents or less, with respect to 1 equivalent of the polyol.

The thermoplastic urethane resin of the resin layer 13 can further include an anti-skid member. As the anti-skid member, for example, non-adhesive substantially spherical particles formed from an inorganic material or an organic material can be used. Specifically, as the anti-skid member, particles formed, for example, from alumina, silica, glass, another metal oxide, a polyester resin, a polystyrene resin, an acrylic resin or a urethane resin can be used. From the perspectives of solvent resistance and strength, as the anti-skid member, glass particles such as soda lime glass particles are preferably used, and soda lime glass 14 with a particle size prescribed by JIS R3301 No. 1 can be used. The particle diameter of this soda lime glass is from 100 μm to 800 μm, for example. A content of the soda lime glass 14 occupying the thermoplastic urethane resin is, for example, not less than 0.1 mass % or not less than 10 mass % and not greater than 50 mass % or not greater than 40 mass %.

The surface coating layer 10 may further contains another resin in addition to a urethane resin. Examples of the resin other than a urethane resin include an acrylic resin, a vinyl chloride resin, a silicone resin, an epoxy resin, a fluorine resin, a melamine resin, an alkyd resin, or a mixture thereof. The surface coating layer 10 has transparency enabling the design layer 10 to be visually recognized from the outside of the decorative sheet 1 for a road surface through the surface coating layer 10. Note that the transparency means that an object present on the opposite side or inside can be seen through the surface coating layer 10, and the transparency also includes translucency.

The surface coating layer 10 includes a top end portion 11. The top end portion 11 is positioned on an uppermost portion of the decorative sheet 1 for a road surface. The decorative sheet 1 for a road surface can further include a retroreflective member 12 on the top end portion 11 of the surface coating layer 10. The retroreflective member 12 includes, for example, glass beads, white silica, and glass prisms. The retroreflective member 12 is produced, for example, by dispersing retroreflective beads into the resin of the surface coating layer 10. To cause retroreflective beads to retroreflect light from the outside of the decorative sheet 1 for a road surface, the retroreflective beads are dispersed to be exposed from the resin of the surface coating layer 10. Since the surface coating layer 10 contains glass beads, the retroreflective member becomes less likely to be affected by changes in an incident direction of external light in retroreflection, and visibility of the decorative sheet for a road surface to a driver or the like of an automobile is further enhanced.

The retroreflective member 12 can also be produced by providing a retroreflective sheet on the surface coating layer 10. The retroreflective sheet is a commercially available glass bead-type or prism-type sheet, for example. An example of the glass bead-type retroreflective sheet is the Scotchlite (trade name) Reflective Sheet 680 Series (available from 3M).

The design layer 20 includes, for example, a supporting layer 22, an ink absorbing layer 24, and an ink layer 26. The supporting layer 22, the ink absorbing layer 24, and the ink layer 26 are provided in this order on the adhesive layer 30.

The supporting layer 22 can contain a material having excellent chemical stability to prevent components such as asphalt constituting the road surface 5 from penetrating when the decorative sheet 1 for a road surface is attached to the road surface 5. In addition, the supporting layer 22 can contain a material having excellent ductility to enable following indentations or protrusions of the road surface 5 when the decorative sheet 1 for a road surface is attached to the road surface 5. Examples of the material for such a supporting layer 22 include metal foil such as aluminum or an aluminum alloy. A thickness of the supporting layer 22 is, for example, from 20 μm to 200 μm.

Indentations or protrusions on the road surface 5 are absorbed by the supporting layer 22, and deformation of characters, figures, or the like of the ink layer 26 formed on the ink absorbing layer 24 is reduced. Since the supporting layer 22 can include aluminum foil, the supporting layer 22 further absorbs indentations or protrusions on the road surface 5, and deformation of characters, figures, or the like depicted by the ink layer 26 on the ink absorbing layer 24 is reduced.

The ink absorbing layer 24 includes, for example, a resin film or sheet containing a white pigment. A white adhesive includes a film or sheet containing, for example, an acrylic polymer, a urethane-based polymer, a polyester such as polyethylene terephthalate (PET), polyvinyl chloride, a polyolefin such as polyethylene and polypropylene (PP), or a fluorinated polymer. Of these specific examples, an acrylic polymer is particularly desirable from the perspective of printability. The white pigment may be an acrylic pressure-sensitive adhesive containing titanium oxide. A thickness of the ink absorbing layer 24 can be, for example, from 3 μm to 500 μm and can also be from 5 μm to 300 μm.

The ink layer 26 is formed on the ink absorbing layer 24 by a printing technique using a colorant such as ink and toner. Examples of the printing technique include gravure printing, screen printing, offset printing, electrostatic printing, inkjet printing, or heat transfer printing. The ink layer 26 on the ink absorbing layer 24 provides a printed image. Characters, figures, or the like can be depicted in detail by the ink layer 26.

Of the various printing techniques described above, the inkjet printing or the heat transfer printing enables various images to be printed easily and can also provide a full-color printed image having outdoor weather resistance. Examples of a printer used in the inkjet printing include a solvent inkjet printer, a UV inkjet printer, or a silk screen. Examples of a printer used in the heat transfer printing include a hot melt type heat transfer printer and a dye-sublimation type heat transfer printer. A specific example of the UV inkjet printer includes a JV5 inkjet printer (available from Mimaki Engineering Co., Ltd.), and a specific example of ink for an inkjet printer includes Mimaki genuine ink (available from Mimaki Engineering Co., Ltd.).

The adhesive layer 30 can be, for example, a thermosensitive adhesive layer formed from a thermosensitive adhesive such as a polyurethane adhesive, a polyester adhesive, a polyolefin adhesive, an acrylic adhesive, and a vinyl chloride adhesive. Of these adhesives, the acrylic adhesive is preferable and the thermosensitive adhesive is particularly desirable from the perspectives of weather resistance and color.

The adhesive layer 30 is constituted, for example, to have a modulus of elasticity at 65° C. of not less than 0.3 MPa. When the modulus of elasticity at 65° C. of the adhesive layer 30 is not less than 0.3 MPa, distortion of decoration due to stationary steering of a vehicle can be suppressed even when the decorative sheet 1 for a road surface is used under a high-temperature environment (for example, 50° C. or greater). From a similar perspective, the modulus of elasticity at 65° C. of the adhesive layer 30 can also be not less than 0.35 MPa or not less than 0.4 MPa. On the other hand, from the perspective of workability, the modulus of elasticity at 65° C. of the adhesive layer 30 is preferably not greater than 10 GPa, more preferably not greater than 5 GPa, and even more preferably not greater than 1 GPa. Here, the “modulus of elasticity” means a storage modulus (G′) measured at a temperature rising rate of 5° C./sec.

Such an adhesive layer 30 can be, for example, a thermosensitive adhesive layer formed from a thermosensitive adhesive such as a polyurethane adhesive, a polyester adhesive, a polyolefin adhesive, an acrylic adhesive, and a vinyl chloride adhesive. Of these adhesives, the acrylic adhesive is preferable and the thermosensitive adhesive is particularly desirable from the perspectives of weather resistance and color. More specifically, the adhesive layer 30 is desirably a thermosensitive adhesive layer exhibiting almost no adhesiveness at 20° C. but exhibiting adhesiveness at 100° C. or higher, for example. Such an adhesive layer 30 contains, for example, a first acrylic polymer having a Tg of not lower than 0° C. and a second acrylic polymer having a Tg of lower than 0° C., and an adhesive containing from 100 to 230 parts by weight of the second acrylic polymer with respect to 100 parts by weight of the first acrylic polymer is preferably used. Further, the adhesive may contain a tackifier being solid at 65° C. and having a melting point of not lower than 80° C. For example, a rosin ester, a terpene phenol, or the like can be used as such a tackifier. Note that the adhesive preferably contains no crosslinking agent. A thickness of the adhesive layer 30 is, for example, not less than 30 μm or not less than 50 μm and not greater than 200 μm or not greater than 150 μm.

In this embodiment, the decorative sheet 1 for a road surface can be installed easily on the road surface 5 with the adhesive layer 30, and a design such as characters and figures can also be applied easily with the design layer 20. Since the surface coating layer 10 provided on the design layer 20 contains a urethane resin, the surface coating layer 10 has high mechanical strength and high torsional resistance. High surface strength is guaranteed by high mechanical strength, and high stationary steering resistance is guaranteed by high torsional resistance. As a result, this decorative sheet 1 for a road surface can have enhanced surface strength with respect to a large vehicle weight of a vehicle and enhanced stationary steering resistance against a steering operation performed while a vehicle is stopped.

Next, the graphic construct 16 for forming the design layer 20 of the decorative sheet 1 for a road surface described above will be described. The graphic construct 16 includes the design layer 20 and the adhesive layer 30, and the design layer 20 present in the graphic construct 16 can include the ink absorbing layer 24 being at least a portion of the design layer 20, and the supporting layer 22 for supporting the ink absorbing layer 24. The supporting layer 22 may include aluminum foil. After production of the graphic construct 16, at another location, for example, on a road surface, the design layer 20 of the graphic construct 16 can be covered with the surface coating layer 10 containing a urethane resin. The adhesive layer 30 is provided on a surface of the opposite side to the surface coating layer 10 of the design layer 20.

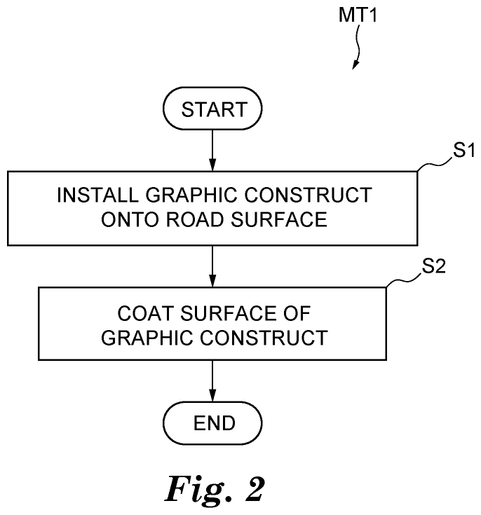

FIG. 2 is a flowchart illustrating a method of installing the decorative sheet for a road surface according to the embodiment. In this installation method MT1, after the graphic construct 16 is first produced, the graphic construct 16 is installed on the road surface 5 (step S1). The graphic construct 16 is installed on the road surface 5 with the adhesive layer 30. The road surface 5 contains asphalt, concrete, or stone. The graphic construct 16 is hit with a tool such as a rubber hammer to be installed on the road surface 5.

In this embodiment, subsequently, the surface coating layer 10 is formed on a surface 16a of the graphic construct 16 installed on the road surface 5 (step S2). That is, in step 2, the surface 16a of the graphic construct 16, and a road surface portion 6 exposed without being covered with the graphic construct 16 around a perimeter of the graphic construct 16, that is, the road surface portion 6 where the graphic construct 16 is not installed are coated with a urethane resin for forming the surface coating layer 10. As a result, the surface coating layer 10 is formed on the surface 16a of the graphic construct 16 and on the road surface portion 6. The retroreflective member 12 can be further provided on the top end portion 11 of the surface coating layer 10. The retroreflective member 12 is produced, for example, by dispersing retroreflective beads onto the urethane resin uncured of the surface coating layer 10.

Note that when the decorative sheet 1 for a road surface is attached onto the road surface 5, a road surface bonding layer 40 may be formed as necessary in advance on the road surface 5 onto which the decorative sheet 1 for a road surface is to be attached (see FIG. 1). The road surface bonding layer 40 is provided to more firmly attach the decorative sheet 1 for a road surface to the road surface 5 together with the adhesive layer 30 of the decorative sheet 1 for a road surface. The road surface bonding layer 40 may contain, for example, the adhesive in the adhesive layer 30, and may contain an epoxy adhesive, a rubber-based adhesive, a chloroprene adhesive, or the like.

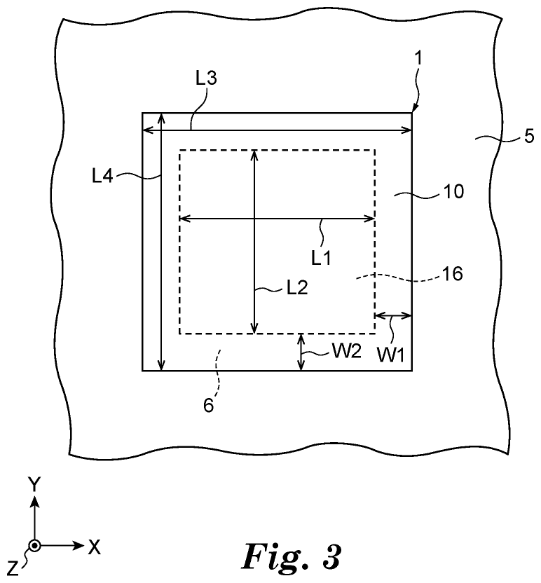

FIG. 3 is a plan view illustrating the decorative sheet for a road surface installed on the road surface according to the embodiment. The decorative sheet 1 for a road surface includes the graphic construct 16 and the surface coating layer 10 covering the graphic construct 16. A shape of the graphic construct 16 is not particularly limited and can be any shape such as a line shape, a circular shape, a rectangular shape such as a rectangle and a square, a polygonal shape, or an amorphous shape, and a size of the graphic construct 16 is also not limited. For example, in the case of the decorative sheet 1 for a road surface including the graphic construct 16 having a rectangular shape, a first length L1 (X-axis direction) of the graphic construct 16 is, for example, from 25 to 10000 mm, and a second length L2 (Y-axis direction) of the graphic construct 16 is, for example, from 25 to 10000 mm. A third length L3 (X-axis direction) of the surface coating layer 10 is, for example, from 27 to 10100 mm, and a fourth length L4 (Y-axis direction) of the surface coating layer 10 is, for example, from 27 to 10100 mm. The surface coating layer 10 is also formed on the road surface portion 6 exposed around the perimeter of the graphic construct 16, and a first width W1 (X-axis direction) of the surface coating layer 10 on the road surface portion 6 is, for example, from 1 to 50 mm, and a second width W2 (Y-axis direction) of the surface coating layer 10 on the road surface portion 6 is, for example, from 1 to 50 mm.

According to the installation method MT1 for a decorative sheet for a road surface, since the graphic construct 16 having flexibility is first installed on the road surface 5, and subsequently coated with a urethane resin having high coatability (including a urethane resin-containing solution) to form the decorative sheet 1 for a road surface, the decorative sheet for a road surface having improved road followability can be installed easily on the road surface 5. In addition, after the coating of the surface coating layer 10, a retroreflective material such as glass beads, an anti-skid agent, or the like can be dispersed on the surface coating layer 10 uncured, and thus can be fixed easily to the top end portion 11 of the surface coating layer 10.

In addition, in step S2, the region coated with the urethane resin includes the road surface portion 6 exposed without being covered with the graphic construct 16 around the perimeter of the graphic construct 16. Since the surface coating layer 10 widely covers not only the top of the graphic construct 16, but also the perimeter of the graphic construct 16 including an end portion of the graphic construct 16, peeling of the decorative sheet 1 for a road surface can be suppressed effectively.

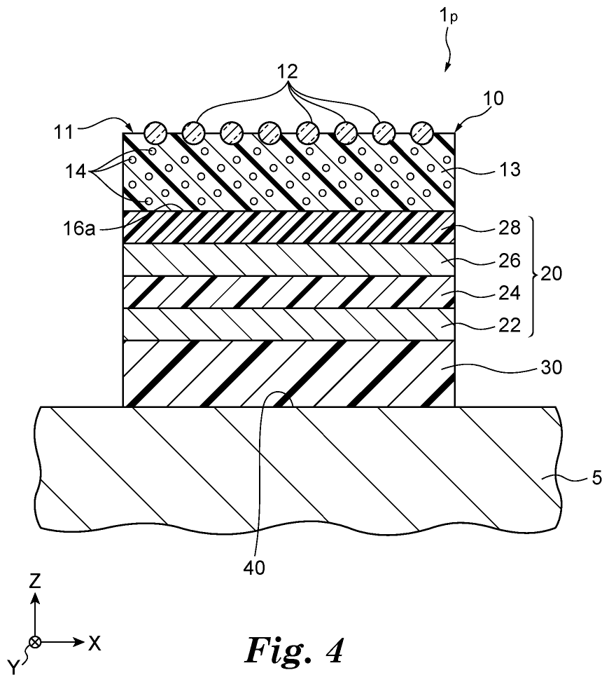

FIG. 4 is a view schematically illustrating a cross section of a decorative sheet for a road surface according to another embodiment of the present invention. In FIG. 4, a decorative sheet 1p for a road surface attached onto a road surface 5 is depicted. The decorative sheet 1p for a road surface includes a surface coating layer 10, a design layer 20, and an adhesive layer 30. The design layer 20 is provided on the adhesive layer 30, and a graphic construct 16 includes the design layer 20 and the adhesive layer 30. The graphic construct 16 is covered with the surface coating layer 10. The adhesive layer 30 is positioned at a lowest portion of the decorative sheet 1p for a road surface. Note that in the decorative sheet 1p for a road surface, the same structures and elements as those of the decorative sheet 1 for a road surface are denoted by the same reference signs, and detailed description thereof will be omitted.

The design layer 20 includes a supporting layer 22, an ink absorbing layer 24, and an ink layer 26, and can further include a transparent resin film that may serve as an ink absorbing layer 28 on the ink layer 26. The transparent resin film is, for example, a cast film molded with polyvinyl chloride, an acrylic resin, or the like, and is a flexible film transparent in the visible range. Note that when the transparent resin film is used as the ink absorbing layer 28, the ink layer 26 can be formed on the transparent resin film. In this case, the ink absorbing layer 24 can also function as a white pressure-sensitive adhesive layer rather than as the ink absorbing layer 24. The decorative sheet 1 for a road surface includes the transparent resin film as the ink absorbing layer and thus, coloring applied to the design layer 20 is maintained for a longer period of time than in a mode where the decorative sheet includes no ink absorbing layer.

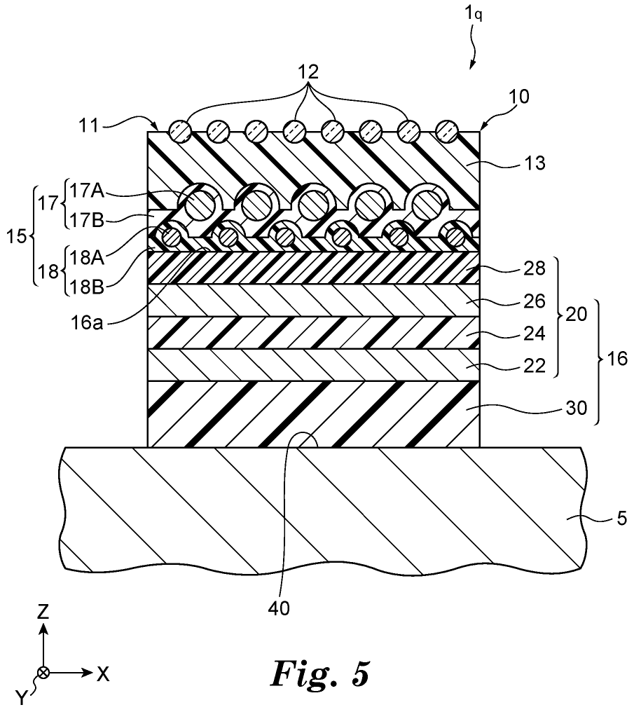

FIG. 5 is a view schematically illustrating a cross section of a decorative sheet for a road surface according to another embodiment of the present invention. In FIG. 5, a decorative sheet 1q for a road surface attached onto a road surface 5 is depicted. The decorative sheet 1q for a road surface includes a surface coating layer 10, a design layer 20, and an adhesive layer 30. The design layer 20 is provided on the adhesive layer 30, and a graphic construct 16 includes the design layer 20 and the adhesive layer 30. The graphic construct 16 is covered with the surface coating layer 10. The adhesive layer 30 is positioned at a lowest portion of the decorative sheet 1q for a road surface. Note that in the decorative sheet 1q for a road surface, the same structures and elements as those of the decorative sheet 1 for a road surface or the decorative sheet 1p for a road surface are denoted by the same reference signs, and detailed description thereof will be omitted.

The surface coating layer 10 of the decorative sheet 1q for a road surface can include a resin layer 13 and an anti-skid layer 15. The anti-skid layer 15 can include, for example, a first bead coat layer 17 and a second bead coat layer 18. The first bead coat layer 17 contains, for example, particles 17A having a particle diameter from 20 μm to 60 μm and an anti-skid resin 17B holding the particles 17A. The second bead coat layer 18 contains particles 18A having a particle diameter from 20 μm to 60 μm and an anti-skid resin 18B holding the particles 18A. The particles 17A or the particles 18A include, for example, particles formed from alumina, silica, glass, another metal oxide, a polyester resin, a polystyrene resin, an acrylic resin or a urethane resin. These particles are applied to the anti-skid resin 17B or the anti-skid resin 18B, and an coating weight of the particles is, for example, from 10 g/m² to 50 g/m². The particles 17A or the particles 18A are an example of an anti-skid member.

Types of the anti-skid resins 17B and 18B are not particularly limited as long as the anti-skid resins 17B and 18B are resins capable of holding the particles 17A and 18A present in the anti-skid layer 15. Specifically, the anti-skid resins 17B and 18B include, for example, a urethane resin, an acrylic resin, a vinyl chloride resin, a silicone resin, an epoxy resin, a fluororesin, a melamine resin, and an alkyd resin or a mixture thereof.

In production of the decorative sheet 1q for a road surface, since an upper face of the anti-skid layer 15 has undulations due to the particles 17A and 18A present in the anti-skid layer 15, undulations are also formed on a surface of the resin layer 13 formed on these undulations, and the surface coating layer 10 having unevenness is formed (the undulations are not illustrated). In the decorative sheet 1q for a road surface, since the surface coating layer 10 includes the anti-skid layer 15 containing the particles 17A and 18A, tires of a vehicle or pedestrians traveling over the decorative sheet 1 for a road surface become difficult to skid.

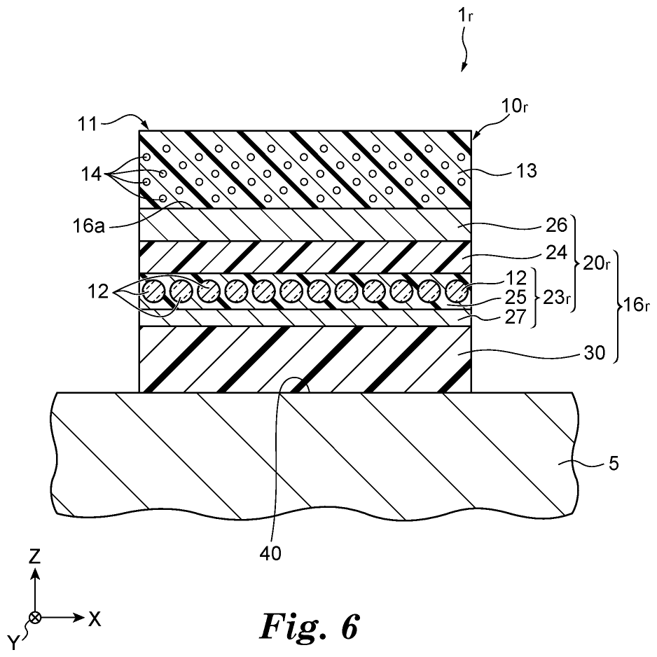

FIG. 6 is a view schematically illustrating a cross section of a decorative sheet for a road surface according to another embodiment of the present invention. In FIG. 6, a decorative sheet 1r for a road surface attached onto a road surface 5 is depicted. The decorative sheet 1r for a road surface includes a surface coating layer 10r, a design layer 20r, and an adhesive layer 30. The design layer 20r is provided on the adhesive layer 30, and a graphic construct 16r includes the design layer 20r and the adhesive layer 30. The graphic construct 16r is covered with the surface coating layer 10r. In this embodiment, the adhesive layer 30 is positioned at a lowest portion of the decorative sheet 1r for a road surface. Note that in the decorative sheet 1r for a road surface, the same structures and elements as those of the decorative sheet 1 for a road surface are denoted by the same reference sings, and detailed description thereof will be omitted.

The surface coating layer 10r includes a resin layer 13, and the resin layer 13 contains, for example, a thermoplastic urethane resin. The thermoplastic urethane resin of the resin layer 13 can further include an anti-skid member. In the decorative sheet 1r for a road surface of this embodiment, in contrast to the decorative sheet 1 for a road surface, the decorative sheet 1p for a road surface, and the decorative sheet 1q for a road surface, the surface coating layer 10r include no retroreflective member.

The design layer 20r includes, for example, a retroreflective layer 23r, an ink absorbing layer 24, and an ink layer 26. The retroreflective layer 23r, the ink absorbing layer 24, and the ink layer 26 can be provided in this order on an adhesive layer 30. The retroreflective layer 23r can be disposed between the ink absorbing layer 24 and the adhesive layer 30.

According to this decorative sheet 1r for a road surface, since the retroreflective layer 23r may be provided between the ink absorbing layer 24 and the adhesive layer 30, that is, beneath the design layer 20r, external light incident inside the decorative sheet 1r for a road surface can pass through the ink absorbing layer 24 of the design layer 20r, and then can be reflected by the retroreflective layer 23r to pass through the ink absorbing layer 24 again. Since external light passing through the ink absorbing layer 24 of the design layer 20r is reflected by the retroreflective layer 23r to pass through the ink absorbing layer 24 again, visibility of characters, figures, or the like applied on the ink absorbing layer 24 to a driver or the like of an automobile is even further enhanced.

The retroreflective layer 23r includes, for example, an intermediate resin layer 25 containing a resin surrounding a retroreflective member 12, and a reflective vapor deposited layer 27 covering the intermediate resin layer 25. The reflective vapor deposited layer 27 is disposed, for example, between the intermediate resin layer 25 and the adhesive layer 30. The retroreflective member 12 of the retroreflective layer 23r is surrounded by the resin in the intermediate resin layer 25 and thus can be held stably.

A type of the intermediate resin layer 25 is not particularly limited as long as the intermediate resin layer 25 contains a resin capable of surrounding the retroreflective member 12. The intermediate resin layer 25 contains, for example, a urethane resin, an acrylic resin, a vinyl chloride resin, a silicone resin, an epoxy resin, a fluororesin, a melamine resin, and an alkyd resin or a mixture thereof.

The reflective vapor deposited layer 27 includes, for example, a metal vapor deposited film such as an aluminum vapor deposited film or a silver vapor deposited film. The reflective vapor deposited layer 27 can further enhance reflection efficiency of the retroreflective layer 23r together with the retroreflective member 12. The reflective vapor deposited layer 27 is produced, for example, by vapor deposition of aluminum or silver. A thickness of the reflective vapor deposited layer 27 is, for example, from approximately 10 nm to 500 nm.

According to this decorative sheet 1r for a road surface, since the reflective vapor deposited layer 27 may be disposed between the intermediate resin layer 25 and the adhesive layer 30, external light incident inside the decorative sheet 1r for a road surface can pass through the ink absorbing layer 24 and the intermediate resin layer 25, and then can be reflected by the reflective vapor deposited layer 27 to pass through the intermediate resin layer 25 and the ink absorbing layer 24 again. As a result, visibility of characters, figures, or the like applied on the ink absorbing layer 24 to a driver or the like of an automobile is enhanced.

The retroreflective member 12 contains, for example, glass beads, white silica, and glass prisms. The retroreflective member 12 is a member for retroreflecting light from the outside of the decorative sheet 1r for a road surface. According to this decorative sheet 1r for a road surface, since the retroreflective member 12 contains glass beads, the retroreflective member becomes less likely to be affected by changes in an incident direction of external light in retroreflection, and visibility of the decorative sheet for a road surface to a driver or the like of an automobile is further enhanced.

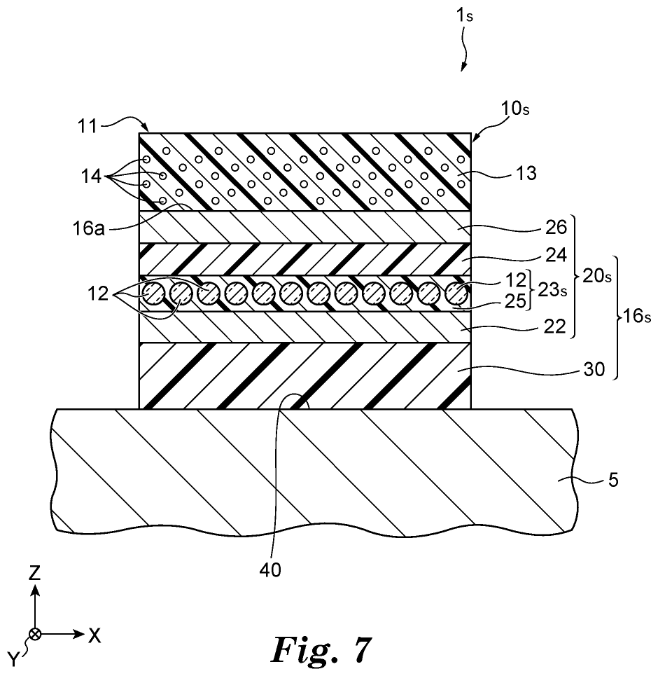

FIG. 7 is a view schematically illustrating a cross section of a decorative sheet for a road surface according to another embodiment of the present invention. In FIG. 7, a decorative sheet is for a road surface attached onto a road surface 5 is depicted. The decorative sheet is for a road surface includes a surface coating layer 10s, a design layer 20s, and an adhesive layer 30. The design layer 20s is provided on the adhesive layer 30, and a graphic construct 16s includes the design layer 20s and the adhesive layer 30. The graphic construct 16s is covered with the surface coating layer 10s. In this embodiment, the adhesive layer 30 is positioned at a lowest portion of the decorative sheet is for a road surface. Note that in the decorative sheet is for a road surface, the same structures and elements as those of the decorative sheet 1 for a road surface are denoted by the same reference sings, and detailed description thereof will be omitted.

The surface coating layer 10s includes a resin layer 13, and the resin layer 13 contains, for example, a thermoplastic urethane resin. The thermoplastic urethane resin of the resin layer 13 can further include an anti-skid member. In the decorative sheet 1s for a road surface of this embodiment, in contrast to the decorative sheet 1 for a road surface, the decorative sheet 1p for a road surface, and the decorative sheet 1q for a road surface, the surface coating layer 10s includes no retroreflective member.

The design layer 20s includes, for example, a supporting layer 22, a retroreflective layer 23s, an ink absorbing layer 24, and an ink layer 26. The supporting layer 22, the retroreflective layer 23s, the ink absorbing layer 24, and the ink layer 26 can be provided in this order on the adhesive layer 30. The supporting layer 22 supports, for example, the retroreflective layer 23s and is disposed between the retroreflective layer 23s and the adhesive layer 30. The supporting layer 22 can include, for example, the same structure as the structure of the supporting layer 22 of the decorative sheet 1 for a road surface, and according to the decorative sheet 1s for a road surface, the supporting layer 22 further absorbs indentations or protrusions on a road surface 5, and deformation of the retroreflective layer 23s is reduced.

The retroreflective layer 23s includes, for example, an intermediate resin layer 25 containing a resin surrounding a retroreflective member 12. The retroreflective layer 23s may further include a reflective vapor deposited layer covering the intermediate resin layer 25 as necessary. The reflective vapor deposited layer is disposed, for example, between the intermediate resin layer 25 and the supporting layer 22. The retroreflective layer 23s may not further include the reflective vapor deposited layer covering the intermediate resin layer 25, and the decorative sheet is for a road surface can include the same structure as the structure of the decorative sheet 1r for a road surface with the exception of the reflective vapor deposited layer and the supporting layer 22 and can include the same materials.

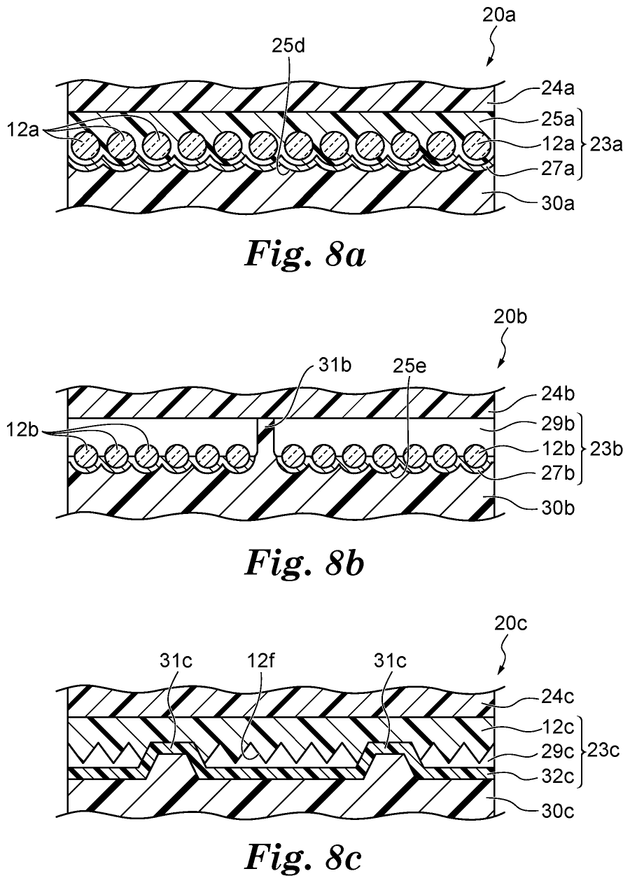

FIG. 8A, FIG. 8B, and FIG. 8C are views each schematically illustrating a cross section of a design layer including a retroreflective layer according to an embodiment.

In a design layer 20a of an example illustrated in FIG. 8A, a retroreflective layer 23a includes, for example, a retroreflective member 12a, an intermediate resin layer 25a surrounding the retroreflective member 12a, and a reflective vapor deposited layer 27a covering the intermediate resin layer 25a. The reflective vapor deposited layer 27a is disposed, for example, between the intermediate resin layer 25a and an adhesive layer 30a.

The retroreflective member 12a is produced, for example, by dispersing glass beads for retroreflection in the intermediate resin layer 25a. After light from the outside of a decorative sheet for a road surface passes through an ink absorbing layer 24a and the intermediate resin layer 25a, the light is reflected by the retroreflective member 12a, and after the light passes through the intermediate resin layer 25a and the ink absorbing layer 24a again, the light is retroreflected toward the outside. The glass beads can be dispersed such that the glass beads may be considered almost as a single layer in the intermediate resin layer 25a.

The reflective vapor deposited layer 27a can cover a lower face 25d of the intermediate resin layer 25a and can also include a structure conforming to a shape of the retroreflective member 12a. For example, when the retroreflective member 12a contains glass beads, the reflective vapor deposited layer 27a can include an indented structure conforming to spherical shapes of the glass beads.

In a design layer 20b of an example illustrated in FIG. 8B, a retroreflective layer 23b includes, for example, a retroreflective member 12b, a reflective vapor deposited layer 27b, and an air layer 29b. The reflective vapor deposited layer 27b, the retroreflective member 12b, and the air layer 29b can be provided in this order on an adhesive layer 30b.

The retroreflective layer 23b includes, for example, a binder part 31b in the air layer 29b, and the binder part 31b can join an ink absorbing layer 24b and the adhesive layer 30b. The binder part 31b may include a structure where the binder part 31b is integrated with the adhesive layer 30b. The binder part 31b enables the air layer 29b to maintain a space of the air layer 29b against weights of people or vehicles traveling over the decorative sheet 1 for a road surface.

The retroreflective member 12b is produced by depositing a metal on a surface including glass beads for retroreflection dispersed densely on a support to form the reflective vapor deposited layer 27b, and then peeling the reflective vapor deposited layer 27b from the support. The deposited metal is, for example, aluminum or silver. After light from the outside of the decorative sheet for a road surface passes through the ink absorbing layer 24b and the air layer 29b, the light is reflected by the retroreflective member 12b, and after the light passes through the air layer 29b and the ink absorbing layer 24b again, the light is retroreflected toward the outside. The glass beads can be dispersed such that the glass beads may be considered almost as a single layer in the intermediate resin layer 25a.

In a design layer 20r of an example illustrated in FIG. 8C, a retroreflective layer 23c includes, for example, an intermediate layer 32c, an air layer 29c, and a retroreflective member 12c. The intermediate layer 32c, the air layer 29c, and the retroreflective member 12c can be provided in this order on an adhesive layer 30c. The intermediate layer 32c includes, for example, a binder part 31c, and the binder part 31c can join an ink absorbing layer 24c and an adhesive layer 30c. The binder part 31c may include a structure where the binder part 31b is integrated with the adhesive layer 30c. The binder part 31c enables the air layer 29c to maintain a space of the air layer 29c against weights of people or vehicles traveling over a decorative sheet for a road surface.

The retroreflective member 12c contains, for example, a thermoplastic resin such as a polycarbonate and an acrylic resin. As the retroreflective 12c, for example, a corner cube having a trigonal pyramidal shape may be used, or instead of the corner cube, a retroreflective member called a full cube may be used. These corner cube and full cube are produced by molding using a mold, for example. The trigonal pyramidal shape of the retroreflective member 12c is a member for retroreflecting light from the outside of the decorative sheet for a road surface. Since the retroreflective layer 23c includes the air layer 29c between the retroreflective member 12c and the intermediate layer 32c, the air layer 29c enables full reflection by the retroreflective member 12c. After the light from the outside passes through the ink absorbing layer 24c, the light is reflected by the retroreflective member 12c, and after the light passes through the ink absorbing layer 24c again, the light is retroreflected toward the outside. A reflective vapor deposited layer containing a metal such as aluminum may be provided as necessary on a lower side 12f of the retroreflective member 12c.

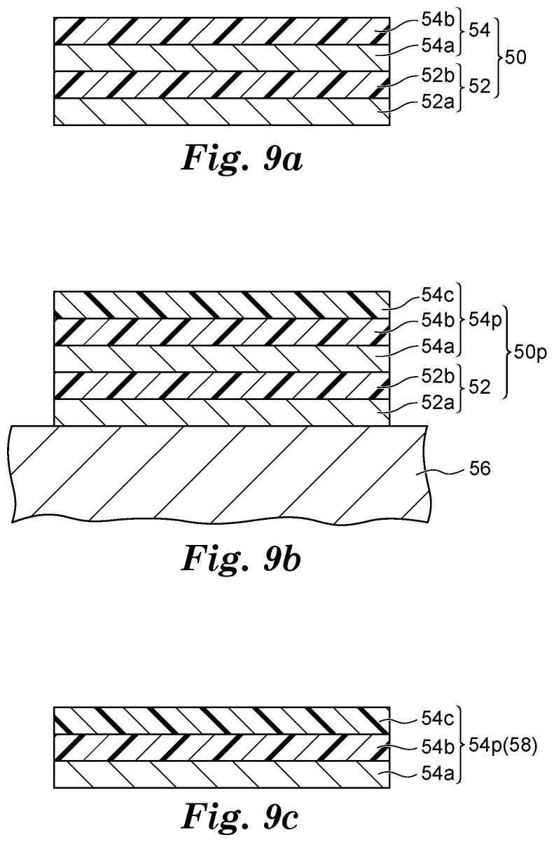

FIG. 9A is a view schematically illustrating a cross section of a precursor for a graphic construct according to an embodiment. A precursor 50 for a graphic construct includes a backing film layer 52 and a pre-design layer 54. The backing film layer 52 includes, for example, a substrate film layer 52a and a pressure-sensitive adhesive layer 52b, and the pre-design layer 54 includes a supporting layer 54a and an ink absorbing layer 54b. The pressure-sensitive adhesive layer 52b is provided, for example, between the substrate film layer 52a and the supporting layer 54a. The backing film layer 52 is peelably bonded to the supporting layer 54a with the pressure-sensitive adhesive layer 52b.

According to this precursor 50, the precursor 50 includes the backing film layer 52, formation stability is high at the time of printing by an inkjet printer or the like, and characters, figures, or the like can be printed clearly on the pre-design layer 54. In addition, since the backing film layer 52 can be peeled easily from a design layer 54p produced by printing on the pre-design layer 54, the design layer 54p can be installed easily on a road surface 5 after the backing film layer 52 is removed.

In addition, the precursor 50 may have a stiffness exceeding 320 mgf and may also have a stiffness of not less than 400 mgf. An upper limit of the stiffness of the precursor 50 can be set appropriately in accordance with a material used, and the precursor 50 may have, for example, a stiffness of not greater than 3000 mgf, and may also have a stiffness of not greater than 2000 mgf. The pressure-sensitive adhesive layer 52b of the backing film layer 52 may have adhesive strength smaller than 0.5 N/25 mm and may also have adhesive strength of not greater than 0.2 N/25 mm. A lower limit of the adhesive strength of the pressure-sensitive adhesive layer 52b can be set appropriately in accordance with a material used, and the pressure-sensitive adhesive layer 52b may have adhesive strength greater than 0.05 N/25 mm, and may also have adhesive strength of not less than 0.1 N/25 mm.

Since this precursor 50 for a graphic construct has a stiffness exceeding 320 mgf, a shape of a sheet can be stable even at the time of printing, and the sheet can be transported smoothly. In addition, since the precursor 50 may have a stiffness exceeding 400 mgf, transportation at the time of printing can be performed even more smoothly. Since the pressure-sensitive adhesive layer 52b of the backing film layer 52 has adhesive strength smaller than 0.5 N/25 mm, the backing film layer 52 can be peeled easily from a printed precursor 50p (see FIG. 9B) after characters, figures, or the like are applied on the pre-design layer 54. The pre-design layer 54 can be installed easily on the road surface 5 by using an adhesive or the like after the backing film layer 52 is removed. In addition, since the pressure-sensitive adhesive layer 52b of the backing film layer 52 may have adhesive strength of not greater than 0.2 N/25 mm, the backing film layer 52 can be peeled even more easily from the printed precursor 50p after characters, figures, or the like are printed on the pre-design layer 54.

The substrate film layer 52a includes, for example, various sheets such as a PET film, paper, a vinyl chloride film, a PP film, or a PE film. A thickness of the substrate film layer 52a may be a thickness at which the precursor 50 having a stiffness exceeding 320 mgf can be realized. For example, in the case of a PET film, the thickness can be not less than 30 μm, not less than 50 μm, or not less than 70 μm, and can also be not greater than 400 μm, not greater than 300 μm, or not greater than 200 μm.

The pressure-sensitive adhesive layer 52b contains, for example, an acrylic pressure-sensitive adhesive, a rubber-based pressure-sensitive adhesive, a silicone pressure-sensitive adhesive, or an acrylic foam agent and may further contain pressure-sensitive microparticles. When the pressure-sensitive adhesive layer 52b contains the pressure-sensitive microparticles, since an uneven surface is formed on a pressure-sensitive adhesive surface, the pressure-sensitive adhesive layer 52b is excellent in air release properties in attaching to the substrate film layer 52a. In addition, since contact area with the substrate film layer 52a is small, it is easy to reduce adhesive strength. Adhesive strength of the acrylic pressure-sensitive adhesive is easily controlled by varying an added amount of a curing agent or a coating weight. For example, in the case of reducing the adhesive strength, an amount of the curing agent may be increased, and the coating weight may be reduced. The coating weight of the pressure-sensitive adhesive layer 52b can be, for example, not greater than 100 g/m², not greater than 40 g/m², or not greater than 30 g/m² and can also be not less than 5 g/m², not less than 6 g/m², or not less than 7 g/m².

According to this precursor 50, the precursor 50 includes the substrate film layer 52a, the precursor 50 has shape stability and excellent transportability at the time of printing, and since the precursor 50 includes the pressure-sensitive adhesive layer 52b, the precursor 50 has excellent adhesiveness and peelability with respect to the supporting layer 54a.

The supporting layer 54a includes, for example, metal foil such as aluminum or an aluminum alloy. A thickness of the supporting layer 54a is, for example, from 20 μm to 200 μm.

The ink absorbing layer 54b includes, for example, a resin film or sheet containing a white pigment. A white adhesive includes a film or sheet containing, for example, an acrylic polymer, a urethane-based polymer, a polyester such as polyethylene terephthalate (PET), polyvinyl chloride, a polyolefin such as polyethylene and polypropylene (PP), or a fluorinated polymer. A thickness of the ink absorbing layer 54b can be, for example, from 3 μm to 500 μm, and can also be from 5 μm to 300 μm.

FIG. 9B is a view schematically illustrating a cross section of a printed precursor on which a design layer is formed according to an embodiment. In contrast to the precursor 50 prior to printing, the printed precursor will be referred to as the “printed precursor 50p” hereinafter. Formation of an ink layer 54c on the ink absorbing layer 54b of the precursor 50 is performed, for example, by introducing the precursor 50 into an inkjet printer and is performed at the printing step of the printer. The precursor 50 can be subjected to inkjet printing in the inkjet printer while the precursor 50 is supported on a holding unit 56, for example. The design layer 54p obtained after the formation of the ink layer 54c includes the supporting layer 54a, the ink absorbing layer 54b, and the ink layer 54c. The printed precursor 50p includes the backing film layer 52 and the design layer 54p. In this embodiment, since the precursor 50 includes the backing film layer 52, the precursor 50 has high formation stability at the time of printing by an inkjet printer or the like and enables characters, figures, or the like to be printed easily and clearly on the pre-design layer 54 to produce the design layer 54p.

FIG. 9C is a view schematically illustrating a cross section of a graphic construct sheet according to an embodiment. A graphic construct sheet 58 refers to the design layer 54p made substantially independent by peeling the backing film layer 52 from the printed precursor 50p. In this embodiment, after the printed precursor 50p is removed from an inkjet printer, the backing film layer 52 can be peeled easily from the printed precursor 50p by a human hand, for example. Production of the graphic construct sheet 58 is complete with the peeling of the backing film layer 52. In this embodiment, after characters, figures, or the like are printed on the pre-design layer 54, the backing film layer 52 can be peeled easily from the printed precursor 50p, and the graphic construct sheet 58 can be installed easily on a road surface 5 by interposing an adhesive layer 30, for example.

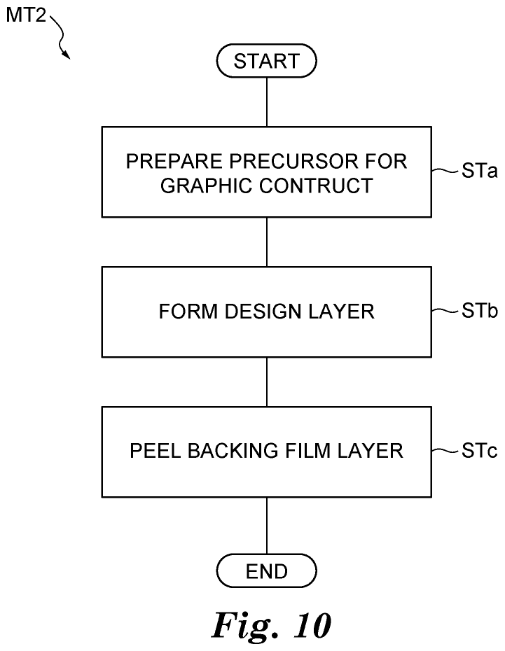

FIG. 10 is a flowchart illustrating a method of producing a graphic construct sheet according to another embodiment. In a production method MT2 of a graphic construct sheet 58, a precursor 50 for a graphic construct is first prepared (step STa). A cross-sectional view of the product produced by this step corresponds to the cross-sectional view of FIG. 9A. The precursor 50 for a graphic construct includes at least an ink absorbing layer 54b, a supporting layer 54a, and a backing film layer 52 in this order. The backing film layer 52 includes a pressure-sensitive adhesive layer 52b.

Subsequently, a design layer 54p is formed by using the precursor 50 prepared at step STa to perform printing on the ink absorbing layer 54b (step STb). A cross-sectional view of the product produced at this step corresponds to the cross-sectional view of FIG. 9B. The precursor 50 is transported into a printer, for example, and printing is then performed on the ink absorbing layer 54b of the precursor 50 to produce a printed precursor 50p. The printed precursor 50p includes the design layer 54p.

In the production method MT2, subsequently, the backing film layer 52 is peeled from the printed precursor 50p on which the design layer 54p is formed (step STc). A cross-sectional view of the product produced at this step corresponds to the cross-sectional view of FIG. 9C. The peeling of the backing film layer 52 can be performed by a human hand, for example. After the backing film layer 52 is peeled from the printed precursor 50p, production of the graphic construct sheet 58 is complete. The graphic construct sheet 58 can be installed, for example, on a road surface 5 by using an adhesive layer 30.

According to this production method MT2 for a graphic construct sheet, the design layer 54p can be formed by using the precursor 50 for a graphic construct to perform printing on the ink absorbing layer 54b by a printer in a factory, for example. After the formation of the design layer 54p, the printed precursor 50p including the design layer 54p obtained after the printing is transported to the road surface 5 over which people or vehicles travel, and after the backing film layer 52 is peeled from the printed precursor 50p and the graphic construct sheet 58 is removed, the graphic construct sheet 58 can be installed easily on the road surface 5.

### EXAMPLES

Hereinafter, a decorative sheet for a road surface will be described further in examples of the present invention and comparative examples. The present invention is not limited to the examples described below.

In the examples, materials shown in Tables 1 and 2 were used. Note that abbreviations in Tables 1 and 2 mean the following compounds.

MMA: Methyl methacrylate

BMA: Butyl methacrylate

DMAEMA: Dimethylaminoethyl methacrylate

BA: n-Butyl acrylate

AA: Acrylic acid

TABLE 1

| | | Glass |
|---|---|---|
| | | transition |
| | | temperature |
| | Composition | (° C.) |
| Acrylic polymer (AP1) | MMA-BMA-DMAEMA = 60:34:6 | 63 |
| Acrylic polymer (AP2) | BA-AA = 90:10 | −44 |
| Acrylic polymer (AP3) | BA-AA = 94:6 | −48 |
| Pigment (PIG1) | Titanium oxide Ti-Pure (trade | — |
| | name) R960 (available from Du | |
| | Pont) | |
| Crosslinking agent | Epoxy-based crosslinking agent | — |
| (CL1) | E-AX (available from Soken | |
| | Chemical & Engineering Co., Ltd.) | |
| Tackifier (TF1) | Rosin ester Haritack F85 (available | — |
| | from Harima Chemicals Group, | |
| | Inc.) | |

TABLE 2

| | | | Resin |
|---|---|---|---|
| | Molecular | | solid |
| | weight | | content |
| | (Mw) | Solvent | (%) |
| Acrylic polymer (AP1) | 68000 | Ethyl acetate | 40 |
| Acrylic polymer (AP2) | 630000 | Toluene/ethyl acetate | 33 |
| Acrylic polymer (AP3) | 760000 | Toluene/ethyl acetate | 33 |
| Pigment (PIG1) | — | — | — |
| Crosslinking agent (CL1) | — | Toluene | 5 |
| Tackifier (TF1) | — | — | — |

### Example 1

### Production of Graphic Construct

Production of Ink Absorbing Layer First, a premix for an ink absorbing layer was prepared. A pigment PIG1 and an acrylic polymer AP1 were dissolved in a methyl isobutyl ketone (MIBK) solvent to prepare a premix solution. In the premix solution, a ratio in terms of resin solid content of the pigment PIG1 to the acrylic polymer AP1 was 5:1, and a proportion of the resin solid content occupying the premix for an ink absorbing layer was 66%.

Subsequently, an acrylic polymer AP1, an acrylic polymer AP2, and a tackifier TF1 were added to the premix solution to prepare a solution for an ink absorbing layer. In the solution for an ink absorbing layer, a ratio in terms of resin solid content of the acrylic polymer AP1 to the acrylic polymer AP2 was 120:100, and a ratio in terms of resin solid content of the tackifier TF1 to the acrylic polymers AP1 and AP2 was 25:100. In addition, a ratio in terms of resin solid content of the pigment PIG1 to the acrylic polymers AP1 and AP2 was 20:100.

Subsequently, the solution for an ink absorbing layer was applied onto a silicone-treated polyester film by a knife coating method. A thickness of the polyester film was 50 μm. The solution for an ink absorbing layer on the polyester sheet was dried for 5 minutes at a temperature of 95° C. and was further dried for 3 minutes at a temperature of 55° C. to produce an ink absorbing layer on the polyester sheet. A thickness of the ink absorbing layer produced was 80 μm.

Subsequently, aluminum foil having a thickness of 50 μm was prepared as a supporting layer for supporting the ink absorbing layer. The ink absorbing layer was attached to the aluminum foil with one face of the ink absorbing layer positioned on the opposite side of the polyester film being interposed between the ink absorbing layer and the aluminum foil. This attachment was performed by a heat laminator method. A roll temperature of a laminator was 90° C. A thickness of the ink absorbing layer supported on the aluminum foil was 80 μm. In the attachment by the heat laminator method, the polyester film on the ink absorbing layer was removed.

### Production of Ink Layer

An ink layer was formed on the other face of the ink absorbing layer positioned on the opposite side of the supporting layer. A UV inkjet printer UJV500 (available from Mimaki) was used in the formation of the ink layer. In this example, blue ink was applied onto the other face of the ink absorbing layer to form an ink absorbing layer. The blue ink was applied to almost all the region on the other face of the ink absorbing layer.

### Production of Adhesive Layer

Subsequently, an adhesive CPG Adhesive I (available from 3M) for commercial packing graphics was prepared as an adhesive layer. The adhesive CPG Adhesive I was applied to a lower face of the supporting layer including aluminum foil to produce a graphic construct including an adhesive layer. The application of the adhesive layer to the supporting layer was performed by using a commercially available paint roller, and the adhesive layer applied was dried for 10 minutes at room temperature. A graphic construct for a decorative sheet for a road surface was produced as a result of the formation of the adhesive layer.

### Installation of Graphic Construct on Road Surface

In this example, the graphic construct was installed on a water-permeable asphalt road surface. Before the graphic construct was installed, an adhesive CPG Adhesive I was applied as a road surface bonding layer and dried on the water-permeable asphalt. The graphic construct including the adhesive layer was attached to the water-permeable asphalt on which the adhesive CPG Adhesive I was applied. This attachment was performed by hitting the graphic construct with a rubber hammer. The graphic construct was attached to follow indentations or protrusions of the water-permeable asphalt.

### Production of Urethane Resin

A mixture for a urethane resin was prepared by mixing a large-area ESG A agent (available from Altech Co., Ltd.) as a polyester polyol and a large-area ESG B agent (available from Altech Co., Ltd.) as a polyisocyanate. An amount of the large-area ESG A agent was 100 g, and an amount of the large-area ESG B agent was 50 g. The mixture was stirred with a spatula, and the stirred mixture was applied onto an upper surface of the graphic construct to form a surface coating layer. The application of the mixture was performed with a commercially available paint roller, and the mixture was also applied onto a surface of the graphic construct and onto a peripheral portion of the graphic construct, that is, the water-permeable asphalt where the graphic construct was not installed. A coating amount of the mixture was 407 g/m². A thickness of the surface coating layer on the surface of the graphic construct was approximately 1 mm.

### Production of Retroreflective Member

After the application onto the water-permeable asphalt, a retroreflective member was provided on the surface coating layer. Retroreflective beads NB-153 (available from Gakunan Kohki Co., Ltd.) were dispersed on a top end portion of the surface coating layer. The retroreflective beads NB-153 are glass beads having a particle diameter of from 106 to 850 μm as prescribed by JIS R3301 No. 1. A refractive index of the glass beads was from 1.50 to 1.64, and a dispersing amount of the glass beads was 160 g/m². The glass beads were dispersed substantially uniformly on the surface coating layer. After the glass beads were dispersed, the surface coating layer was cured overnight at room temperature. After the curing of the surface coating layer, application of a decorative sheet for a road surface according to Example 1 onto the water-permeable asphalt was complete. The decorative sheet for a road surface according to Example 1 has a size of a width of 250 mm, a length of 250 mm, and a thickness of 0.25 mm. Note that in Example 1, a decorative sheet for a road surface applied onto concrete was further prepared.

### Whitening Impact Test

A whitening impact test was performed to confirm application properties of the decorative sheet for a road surface onto water-permeable asphalt. The decorative sheet for a road surface on the water-permeable asphalt was hit lightly 100 times with a hammer including a head having a bolt shape, and presence or absence of whitening of the sheet due to peeling between the surface coating layer and the ink layer was confirmed visually. A weight of the head of the hammer was 0.123 kg.

### Retroreflectivity Performance Test

Retroreflectivity performance was measured by using a reflected brightness meter MIROLUX 7 (available from Potters-Ballotini). The reflected brightness meter included a projector and a photodetector, and the surface coating layer of the decorative sheet for a road surface was irradiated with light by the projector. This irradiation light was retroreflected by the retroreflective beads of the surface coating layer to be incident on the photodetector. In this example, reflected brightness (mdc/lx/m²) was estimated from an amount of light incident on the photodetector. In the retroreflectivity performance test, the decorative sheet for a road surface installed on the concrete was used.

### Anti-Skid Performance Test

Anti-skid performance was measured in a state in which water was sufficiently sprayed onto the decorative sheet for a road surface by using a tester British Pendulum Tester (available from MUNRO Instrument). Friction resistance between a sliding piece attached to a tip of a pendulum of the tester and the surface coating layer of the decorative sheet for a road surface was measured, and the anti-skid performance (BPN) was estimated. This estimation was performed in accordance with the provision ASTM E303-93 (2013). In the anti-skid performance test, the decorative sheet for a road surface installed on the concrete was used.

### Surface Strength Test

A knife-shaped probe was pressed against the decorative sheet for a road surface, and force applied to the probe until any damage occurred in the design layer of the decorative sheet for a road surface was measured. A maximum value (N) of the force applied to the probe was read with a digital force gauge. The probe had a sharp tip end portion cut into a V-shape, and a degree of opening of the V-shape at the tip end portion was 60 degrees. In the surface strength test, the decorative sheet for a road surface installed on water-permeable asphalt was used.

### Stationary Steering Test

Tires of a car were installed over a central portion of the decorative sheet for a road surface, and the tires were rotated over the decorative sheet for a road surface to reproduce the same operation as stationary steering. The tires were of Sneaket 215/65-R16 (available from Bridgestone). A load applied to the decorative sheet for a road surface was 5 kN. The tires were rotated 40 degrees clockwise from a direction of a starting point and returned to the direction of the starting point. This operation was defined as a first cycle. Subsequently, the tires were rotated 40 degrees counterclockwise from the direction of the starting point and returned to the direction of the starting point, and this was defined as a second cycle. Subsequently, the same operation as the first cycle was performed as a third cycle. The same operations were repeated thereafter. After 150 cycles were carried out, a state of damage of the design layer of the decorative sheet for a road surface was observed visually. A proportion of area of the damage by stationary steering out of area of the decorative sheet for a road surface being in contact with the tires was estimated.

### Edge Test

A concrete slab having a length of 300 mm on each side was prepared, and two decorative sheets for a road surface were attached side-by-side on the concrete slab. A size of each of the decorative sheets for a road surface was set to a size of a width of 100 mm and a length of 270 mm. The two decorative sheets for a road surface were installed at an interval of approximately 30 mm. As in the stationary steering test, tires of a car were installed over the decorative sheets for a road surface, and the tires were rotated. The tires were installed to be positioned between the two decorative sheets for a road surface. As in the stationary steering test, after 150 cycles of rotation of the tires were carried out, a proportion (%) of area of peeling by stationary steering out of area of the two decorative sheets for a road surface (54000 mm²) was estimated.

### Example 2

In Example 2, a decorative sheet for a road surface including the same configuration as in Example 1 was produced with the exception that a design layer had the following ink absorbing layer.

### Production of Graphic Construct

### Production of Ink Absorbing Layer

A film not including the pressure-sensitive adhesive layer of Scotchcal (trade name) graphic film RG5333R (available from 3M) was prepared as an ink absorbing layer. This film is a cast film containing polyvinyl chloride and is a flexible film transparent in the visible range. A thickness of the film was 50 μm. In this example, an ink layer was formed on this film. A UV inkjet printer UJV500 (available from Mimaki) was used in the formation of the ink layer. Blue ink was applied onto the graphic film RG5333R to form an ink layer. The blue ink was applied to almost all the region on the film. The ink absorbing layer according to Example 2 was produced as a result of the formation of the ink layer on this film.

### Mounting of Ink Absorbing Layer

Subsequently, as in Example 1, the ink absorbing layer was mounted on a supporting layer. The mounting of this ink absorbing layer was performed by using a heat laminate method. A temperature of the roller at the time of lamination was 130° C. After the lamination, the supporting layer on which the ink absorbing layer was mounted was placed in an oven at a temperature of 95° C. for 40 minutes. After the supporting layer was removed from the oven, an adhesive layer was formed as in Example 1 to produce a graphic construct according to Example 2.

### Installation of Graphic Construct on Road Surface

Subsequently, as in Example 1, the graphic construct was installed on water-permeable asphalt, and a surface coating layer was provided on a surface of the graphic construct. In addition, as in Example 1, a retroreflective member was produced, and application of the decorative sheet for a road surface according to Example 2 onto the water-permeable asphalt was complete. A size of the decorative sheet for a road surface according to Example 2 was the same as the size of the decorative sheet for a road surface according to Example 1, and as in Example 1, a decorative sheet for a road surface applied to concrete was further prepared. In Example 2, as in Example 1, a whitening impact test, a retroreflectivity performance test, an anti-skid performance test, a surface strength test, and a stationary steering test were performed.

### Example 3

In Example 3, a decorative sheet for a road surface including the same configuration as in Example 2 was produced with the exception that a material present in the ink absorbing layer according to Example 2 was changed.

### Production of Ink Absorbing Layer

In Example 3, a flexible acrylic cast film was produced in accordance with the following production procedure as a film for the ink absorbing layer. That is, an acrylic polymer AP1, an acrylic polymer AP3, and a crosslinking agent CL1 were mixed at a ratio in terms of solid content of the acrylic polymer AP1, the acrylic polymer AP3, and the crosslinking agent CL1 of 100:110:0.22. A TK Autohomomixer (available from Primix Corporation) was used for the mixing. Subsequently, the solution for an ink absorbing layer obtained after the mixing was applied onto a silicone-treated polyester film by a knife coating method. A thickness of the polyester film was 50 μm. The solution for an ink absorbing layer on the polyester sheet was dried for 5 minutes at a temperature of 95° C. and was further dried for 2 minutes at a temperature of 155° C. to produce an ink absorbing layer on the polyester sheet. A thickness of the produced ink absorbing layer was 50 μm.

In Example 3, as in Example 1, a whitening impact test, a retroreflectivity performance test, an anti-skid performance test, a surface strength test, and a stationary steering test were performed.

### Comparative Example 1

In Comparative Example 1, a Scotchcal (trade name) paint film CPG-II (available from 3M) was prepared as a decorative sheet for a road surface. An ink absorbing layer of this paint film CPG-II was subjected to blue printing. Note that an adhesive CPG Adhesive I for commercial packing graphics used in the Scotchcal (trade name) paint film CPG-II (available from 3M) (referred to as the “adhesive CPG Adhesive I” hereinafter) was prepared as an adhesive layer. In this Comparative Example 1, a surface coating layer includes in advance a surface layer including an anti-skid member containing a bead coat, together with a design layer and the adhesive layer, and in contrast to the examples, no coating layer of a urethane resin is formed.

In Comparative Example 1, the decorative sheet for a road surface was installed on water-permeable asphalt and on concrete by the same method as the method used for the graphic constructs of the examples.

In Comparative Example 1, as in Example 1, a whitening impact test, a retroreflectivity performance test, an anti-skid performance test, a surface strength test, a stationary steering test, and an edge test were performed. In the edge test, 5 cycles of rotation of tires were carried out.

Table 3 shows the configurations and test results of the decorative sheets for a road surface according to Examples 1 to 3 and Comparative Example 1. In a test results section of Table 3, evaluation results for the whitening impact test, the retroreflectivity performance test, the anti-skid performance test, the surface strength test, the stationary steering test, and the edge test are shown.

In a whitening impact test section of Table 3, as a result of observing the presence or absence of whitening, a case where the whitening was not observed was evaluated as “A (pass),” and a case where the whitening was observed was evaluated as “B (fail).” In a surface strength test section, for example, “>76.5,” indicates that the surface strength test results in not less than 76.5 (N). In a stationary steering test, as a result of estimation, a case where a proportion of area of damage was less than 10% was evaluated as “A (pass),” and a case where a proportion of area of damage was 10% or greater was evaluated as “B (fail).”

TABLE 3

| | | | | Comparative |
|---|---|---|---|---|
| | Example 1 | Example 2 | Example 3 | Example 1 |
| Surface coating layer | ESG A agent | ESG A agent | ESG A agent | No |
| urethane resin | ESG B agent | ESG B agent | ESG B agent | |
| Retroreflective member | NB-153 | NB-153 | NB-153 | No |
| Anti-skid member | ESG A agent | ESG A agent | ESG A agent | — |
| | ESG B agent | ESG B agent | ESG B agent | |
| Whitening impact test | A | A | A | A |
| Retroreflectivity | 49 | 52 | 49 | 0 |
| performance test | | | | |
| (mcd/lx/m²) | | | | |
| Anti-skid performance | 46 | 46 | 46 | 42 |
| test | | | | |
| (BPN) | | | | |
| Surface strength test | >76.5 | >77.3 | >78.6 | 37.5 |
| (N) | | | | |
| Stationary steering test | A | A | A | B |
| [On water-permeable | | | | |
| asphalt] | | | | |
| Stationary steering test | A | A | A | A |
| [On concrete] | | | | |
| Edge strength test (%) | 0.2 | — | — | 1.2 |
| [On concrete] | | | | |

### Example 4

In Example 4, a decorative sheet for a road surface including the same configuration as in Example 1 was produced with the exception that an anti-skid member was provided on a surface coating layer. In Example 4, the anti-skid member is provided on a graphic construct for the decorative sheet for a road surface. A Scotchcal (trade name) paint film CPG-II (available from 3M) was prepared as the graphic construct including this anti-skid member. This paint film CPG-II was not subjected to printing.

### Production of Adhesive Layer

Subsequently, an adhesive CPG Adhesive I (available from 3M) was prepared as an adhesive layer. The adhesive CPG Adhesive I was applied to a lower face of a supporting layer including aluminum foil of the paint film CPG-II to produce the graphic construct including the adhesive layer. The application of the adhesive layer to the supporting layer was performed by using a commercially available paint roller, and the applied adhesive layer was dried for 10 minutes at room temperature.

In this example, the graphic construct was installed on concrete. Before the graphic construct was installed, an adhesive CPG Adhesive I was applied as a road surface bonding layer and dried on the concrete. The graphic construct including the adhesive layer was attached to the concrete on which the adhesive CPG Adhesive I was applied. This attachment was performed by hitting the graphic construct with a rubber hammer.

### Production of Surface Coating Layer

A mixture for a urethane resin was prepared by mixing a large-area ESG A agent (available from Altech Co., Ltd.) as a polyester polyol and a large-area ESG B agent (available from Altech Co., Ltd.) as a polyisocyanate. An amount of the large-area ESG A agent was 100 g, and an amount of the large-area ESG B agent was 50 g. The mixture was stirred with a spatula, and the stirred mixture was applied onto a surface of the graphic construct to form the surface coating layer. The application of the mixture was performed with a commercially available paint roller, and the mixture was also applied onto the surface of the graphic construct, and onto a peripheral portion of the graphic construct, that is, water-permeable asphalt where the graphic construct was not installed. A coating amount of the mixture was 180 g/m². A thickness of the surface coating layer on the surface of the graphic construct (paint film CPG-II) was approximately 1 mm.

### Production of Retroreflective Member

As in Example 1, a retroreflective member was provided on the surface coating layer. Retroreflective beads NB-153 (available from Gakunan Kohki Co., Ltd.) were dispersed on a top end portion of the surface coating layer. The retroreflective beads NB-153 are glass beads having a particle diameter of from 106 to 850 μm as prescribed by JIS R3301 No. 1. A refractive index of the glass beads was from 1.50 to 1.64, and a dispersing amount of the glass beads was 160 g/m². The glass beads were dispersed uniformly on the top end portion of the surface coating layer. After the glass beads were dispersed, the surface coating layer was cured overnight at room temperature. After the curing of the surface coating layer, the application of the decorative sheet for a road surface according to Example 4 to the water-permeable asphalt was complete.

In Example 4, a retroreflectivity performance test and an anti-skid performance test were performed under the same conditions as in Example 1.

### Example 5

In Example 5, a decorative sheet for a road surface including the same configuration as in Example 4 was produced with the exception that the retroreflective member was changed. Glass beads HGB-153 (available from Potters-Ballotini) were used as retroreflective beads. A particle diameter of the glass beads was from 106 to 850 μm. A refractive index of the glass beads was 1.9, and a dispersing amount of the glass beads was 160 g/m². In Example 5, as in Example 4, a retroreflectivity performance test and an anti-skid performance test were performed.

### Example 6

In Example 6, a decorative sheet for a road surface including the same configuration as in Example 4 was produced with the exception that the retroreflective member was changed. A white silica 20-40 mesh product (available from Yamamori Tsuchimoto Inc.) was used as retroreflective beads. A particle diameter of the white silica was from 0.4 to 0.8 mm, and a dispersing amount of the white silica was 80 g/m². In Example 6, as in Example 4, a retroreflectivity performance test and an anti-skid performance test were performed.

### Example 7

In Example 7, a decorative sheet for a road surface including the same configuration as in Example 4 was produced with the exception that the retroreflective member was changed. A white silica 20-40 mesh product (available from Yamamori Tsuchimoto Inc.) and a retroreflective sand core element R-SCE RI 2.2-2.4 (available from 3M) were used as retroreflective beads. A weight ratio of the white silica to the retroreflective sand core element was 50:50. A particle diameter of the white silica was from 0.4 to 0.8 mm, and a particle diameter of the sand core element was from 0.6 to 1.7 mm. A dispersing amount of each of the white silica and the sand core element was 80 g/m². In Example 7, as in Example 4, a retroreflectivity performance test and an anti-skid performance test were performed.

### Example 8

In Example 8, a decorative sheet for a road surface including the same configuration as in Example 4 was produced with the exception that the retroreflective member was changed. A white silica 20-40 mesh product (available from Yamamori Tsuchimoto Inc.) and glass beads HGB-153 (available from Potters-Ballotini) were used as retroreflective beads. A weight ratio of the white silica to the glass beads was 50:50. A particle diameter of the white silica was from 0.4 to 0.8 mm, and a particle diameter of the glass beads was from 106 to 850 μm. A dispersing amount of each of the white silica and the glass beads was 80 g/m². In Example 8, as in Example 4, a retroreflectivity performance test and an anti-skid performance test were performed.

### Comparative Example 2

In Comparative Example 2, a Scotchcal (trade name) paint film CPG-II (available from 3M) was prepared as a decorative sheet for a road surface. This paint film CPG-II was not subjected to printing. An adhesive CPG Adhesive I was prepared as an adhesive layer.

Table 4 shows the configurations and test results of the decorative sheets for a road surface according to Examples 4 to 6, and Table 5 shows the configurations and test results of the decorative sheets for a road surface according to Examples 7 and 8 and Comparative Example 2. In test results sections of Tables 4 and 5, evaluation results for the retroreflectivity performance test and the anti-skid performance test are shown. In sections indicating the configurations (the anti-skid member, the ink absorbing layer, and the supporting layer) of the decorative sheets for a road surface in Tables 6 and 7, the notation “CPG-I” means that the Scotchcal (trade name) paint film CPG-I (available from 3M) was used.

TABLE 4

| | Example 4 | Example 5 | Example 6 |
|---|---|---|---|
| Surface coating layer | ESG A agent | ESG A agent | ESG A agent |
| urethane resin | ESG B agent | ESG B agent | ESG B agent |
| Retroreflective member | NB-153 | HGB-153 | White silica |
| Retroreflectivity | 92 | 120 | 68 |
| performance test | | | |
| (mcd/lx/m²) | | | |
| Anti-skid performance test | 50 | 50 | 91 |
| (BPN) | | | |

TABLE 5

| | | | Comparative |
|---|---|---|---|
| | Example 7 | Example 8 | Example 2 |
| Surface coating layer | ESG A agent | ESG A agent | No |
| urethane resin | ESG B agent | ESG B agent | |
| Retroreflective member | White silica | White silica | No |
| | R-SCE | HGB-153 | |
| Retroreflectivity | 268 | 100 | 45 |
| performance test | | | |
| (mcd/lx/m²) | | | |
| Anti-skid performance test | 94 | 80 | 45 |
| (BPN) | | | |

The decorative sheet for a road surface will be described further hereinafter in Examples 9 to 11 of the present invention and Comparative Examples 3 to 5. Note that in Examples 9 to 11 and Comparative Examples 3 to 5, since the retroreflectivity performance was not evaluated, no retroreflective member was provided. The present invention is not limited to the examples described below.

### Example 9

In Example 9, a Stamark (trade name) primer P-48 (available from 3M) was first applied onto concrete as a road surface bonding layer. A paint roller was used to apply the road surface bonding layer, and after the road surface bonding layer was applied, the road surface bonding layer was dried for 10 minutes at room temperature. Subsequently, a sidewalk film (Scotchcal (trade name) graphic film, available from 3M) was prepared as a graphic construct, and the sidewalk film was attached onto the concrete on which the road surface bonding layer was applied. This attachment was performed by hitting the sidewalk film with a rubber hammer. The sidewalk film substantially includes an anti-skid member, an ink absorbing layer, and a supporting layer.

### Production of Surface Coating Layer

A surface coating layer was formed under the same conditions as in Example 1. A mixture for a urethane resin was prepared by mixing a large-area ESG A agent (available from Altech Co., Ltd.) as a polyester polyol and a large-area ESG B agent (available from Altech Co., Ltd.) as a polyisocyanate. An amount of the large-area ESG A agent was 100 g, and an amount of the large-area ESG B agent was 50 g. The mixture was stirred with a spatula, and the stirred mixture was applied onto a surface of a graphic construct to form a surface coating layer. The application of the mixture was performed with a commercially available paint roller, and the mixture was also applied onto the surface of the graphic construct, and onto a peripheral portion of the graphic construct, that is, water-permeable asphalt where the graphic construct was not installed. A coating amount of the mixture was 180 g/m². A thickness of the surface coating layer on the surface of the graphic construct (sidewalk film) was approximately 1 mm.

In Example 9, a surface strength test and a stationary steering test were performed under the same conditions as in Example 1. In the stationary steering test, 15 cycles of rotation of tires were carried out.

### Example 10

In Example 10, a decorative sheet for a road surface was installed on concrete as in Example 9 with the exception that a hybrid sidewalk film (Scotchcal (trade name) graphic film, available from 3M) was used as a graphic construct. The hybrid sidewalk film substantially includes an anti-skid member, an ink absorbing layer, and a supporting layer. In Example 10, as in Example 9, a surface strength test and a stationary steering test were performed. In the stationary steering test, 15 cycles of rotation of tires were carried out.

### Example 11

In Example 11, a decorative sheet for a road surface was installed on concrete as in Example 9 with the exception that a primer DP-900N3 (available from 3M) was used as a road surface bonding layer and that a Scotchcal (trade name) paint film CPG-I (manufactured by 3M) was used as a graphic construct. The Scotchcal (trade name) paint film CPG-I substantially includes an anti-skid member, an ink absorbing layer, and a supporting layer. In Example 11, as in Example 9, a surface strength test and a stationary steering test were performed. In the stationary steering test, 15 cycles of rotation of tires were carried out.

### Comparative Example 3

In Comparative Example 3, a decorative sheet for a road surface was installed on concrete as in Example 9 with the exception that no surface coating layer was provided. In Comparative Example 3, as in Example 9, a surface strength test and a stationary steering test were performed. In the stationary steering test, 5 cycles of rotation of tires were carried out.

### Comparative Example 4

In Comparative Example 4, a decorative sheet for a road surface was installed on concrete as in Example 10 with the exception that no surface coating layer was provided. In Comparative Example 4, as in Example 9, a surface strength test and a stationary steering test were performed. In the stationary steering test, 5 cycles of rotation of tires were carried out.

### Comparative Example 5

In Comparative Example 5, a decorative sheet for a road surface was installed on concrete as in Example 11 with the exception that no surface coating layer was provided. In Comparative Example 5, as in Example 9, a surface strength test and a stationary steering test were performed. In the stationary steering test, 5 cycles of rotation of tires were carried out.

Table 6 shows the configurations and test results of the decorative sheets for a road surface according to Examples 9 to 11, and Table 7 shows the configurations and test results of the decorative sheets for a road surface according to Comparative Examples 3 to 5. In test results sections of Tables 6 and 7, evaluation results for a surface strength test and a stationary steering test [on concrete] are shown.

In sections indicating the configurations (the anti-skid member, the ink absorbing layer, and the supporting layer) of the decorative sheets for a road surface in FIGS. 6 and 7, the notation “sidewalk,” “hybrid sidewalk,” and “CPG-I” indicate that, of materials present in the sidewalk or the like, a material corresponding to each of the anti-skid member, the ink absorbing layer, and the supporting layer was used. In addition, in the stationary steering test, a case where the decorative sheet for a road surface did not peel from the concrete was evaluated as “A (pass),” and a case where the decorative sheet for a road surface peeled from the concrete was evaluated as “B (fail).”

TABLE 6

| | Example 9 | Example 10 | Example 11 |
|---|---|---|---|
| Surface coating layer | ESG A agent | ESG A agent | ESG A agent |
| urethane resin | ESG B agent | ESG B agent | ESG B agent |
| Anti-skid member | Sidewalk | Hybrid sidewalk | CPG-I |
| Ink absorbing layer | Sidewalk | Hybrid sidewalk | CPG-I |
| Supporting layer | Sidewalk | Hybrid sidewalk | CPG-I |
| Surface strength test | 34.6 | 48.4 | 52.2 |
| (N) | | | |
| Stationary steering test | A | A | A |
| [On concrete] | | | |

TABLE 7

| | Comparative | Comparative | Comparative |
|---|---|---|---|
| | Example 3 | Example 4 | Example 5 |
| Surface coating layer | No | No | No |
| urethane resin | | | |
| Anti-skid member | Sidewalk | Hybrid sidewalk | CPG-I |
| Ink absorbing layer | Sidewalk | Hybrid sidewalk | CPG-I |
| Supporting layer | Sidewalk | Hybrid sidewalk | CPG-I |
| Surface strength test | 20.7 | 26.1 | 27.3 |
| (N) | | | |
| Stationary steering test | B | B | B |
| [On concrete] | | | |

The decorative sheet for a road surface will be described further hereinafter in Examples 12 and 13 of the present invention. The present invention is not limited to the examples described below.

### Example 12

### Production of Design Layer

First, a vinyl chloride transparent sheet for JS1900 having a thickness of 50 μm (available from 3M) was prepared on presized paper. Then, a butanol solution of a mixture containing an acrylic resin (32 mass %) and retroreflective glass beads (68 mass %) was slurry-coated onto the presized paper. Elvacite 2044 (available from Lucite Japan) was used for the acrylic resin, and 5318 3635 Bead TILLOY (available from 3M) was used for the retroreflective glass beads. The retroreflective beads are glass beads having a particle diameter of from 44 to 62 μm. A refractive index of the glass beads was from 2.1 to 2.3, and a content of the glass beads in the acrylic resin was 126 g/m². The glass beads were dispersed substantially uniformly in the acrylic resin. After the slurry coating, the presized paper was dried for 5 minutes at a temperature of 65° C. and subsequently dried for 3 minutes at a temperature of 95° C. to produce a slurry coat layer. The slurry coat layer is a layer for an intermediate resin layer containing a resin surrounding a retroreflective member. A thickness of the slurry coat layer was 120 μm.

Next, a reflective vapor deposited layer including an aluminum deposited layer was formed on the slurry coat layer by using a vapor deposition device EX200 (available from ULVAC). In this example, a thickness of the reflective vapor deposited layer was approximately 100 nm. After the vapor deposition of aluminum, the slurry coat layer including the reflective vapor deposited layer was cut to have a size of 190 mm×250 mm.

Then, an ink layer was formed on the ink absorbing layer. A UV inkjet printer UJV500 (available from Mimaki) was used in the formation of the ink layer. LUS-200 ink (available from Mimaki) was applied onto a surface of a face of the vinyl chloride transparent sheet for JS1900 from which the presized paper was peeled, and the ink layer was formed. The ink was applied to substantially all the region on the film. A design layer according to this example was produced as a result of the formation of the ink layer on this film.

### Production of Graphic Construct

An adhesive CPG Adhesive I (available from 3M) was prepared as an adhesive layer. Subsequently, an adhesive CPG Adhesive I (available from 3M) was similarly applied on a lower face of the reflective vapor deposited layer. The application of the adhesive layer to the reflective vapor deposited layer was performed by using a commercially available paint roller, and the applied adhesive layer was dried for 10 minutes at room temperature. A graphic construct for a decorative sheet for a road surface was produced as a result of the formation of the adhesive layer.

### Installation of Graphic Construct on Road Surface

In this example, the graphic construct was divided into two sheets each having a size of 95 mm×250 mm, and the two sheets of the divided graphic constructs were installed on a concrete slab. A size of the concrete slab was 300 mm×300 mm×50 mm. Before the graphic constructs were installed, an adhesive CPG-Adhesive I was applied onto the concrete slab and then dried for 10 minutes at room temperature to produce a road surface bonding layer. A hand roller was used to apply the adhesive CPG-Adhesive I. Area of the road surface bonding layer was 105 mm×260 mm. Subsequently, the graphic constructs each including the adhesive layer was attached to the concrete slab on which the road surface bonding layer was provided. This attachment was performed by hitting the graphic constructs with a rubber hammer. The graphic constructs were attached to follow indentations or protrusions of the concrete slab.

### Production of Surface Coating Layer

A mixture for a urethane resin was prepared by mixing a large-area ESG A agent (available from Altech Co., Ltd.) as a polyester polyol and a large-area ESG B agent (available from Altech Co., Ltd.) as a polyisocyanate. An amount of the large-area ESG A agent was 100 g, and an amount of the large-area ESG B agent was 50 g. The mixture was stirred with a spatula, and the stirred mixture was applied onto upper surfaces of the graphic constructs to form a surface coating layer. The application of the mixture was performed with a commercially available paint roller, and the mixture was also applied onto surfaces of the graphic constructs, and onto peripheral portions of the graphic constructs, that is, the concrete slab where the graphic constructs were not installed. A coating amount of the mixture was 310 g/m². A thickness of the surface coating layer on the surfaces of the graphic constructs was approximately 1 mm. The surface coating layer was also formed on the concrete slab exposed around the perimeters of the graphic constructs, and a width of the surface coating layer on the concrete slab was approximately 5 mm, for example. Production of the surface coating layer was complete after the mixture was applied and then left to stand overnight at room temperature. Production of a decorative sheet for a road surface of this example was complete as a result of the production of the surface coating layer.

### Graphical Image Observation

A graphical image was observed on the decorative sheet for a road surface. Specifically, a smart phone iPhone 7 (trade name, available from Apple) was used, and an inkjet graphical image depicted on the design layer of the decorative sheet for a road surface was captured by using the smart phone while irradiation is performed at an incident angle of 30 degrees with flash of the smart phone. As a result of the image capturing, a case where a bright graphical image was obtained was evaluated as “good (A),” and a case where a dull graphical image was obtained was evaluated as “poor (B).”

### Retroreflectivity Performance Test

The decorative sheet for a road surface was attached to an aluminum plate, and a retroreflectivity performance test was performed. A size of the aluminum plate was 210 mm×150 mm×0.5 mm. In measurement of retroreflectivity performance, reflected brightness (cd/lx/m²) was estimated in accordance with JIS Z9117. The decorative sheet for a road surface was not subjected to inkjet printing.

### Stationary Steering Test

The decorative sheet for a road surface was provided on a concrete material, and tires of a car were also installed over a central portion of the decorative sheet for a road surface. Subsequently, the tires were rotated over the decorative sheet for a road surface to reproduce the same operation as stationary steering. The tires were NEXTRY 215/65R16 98H (available from Bridgestone). A load applied to the decorative sheet for a road surface was 5 kN. The tires were rotated 40 degrees clockwise from a direction of a starting point and returned to the direction of the starting point. This operation was defined as a first cycle. Subsequently, the tires were rotated 40 degrees counterclockwise from the direction of the starting point and returned to the direction of the starting point, and this was defined as a second cycle. Subsequently, the same operation as the first cycle was performed as a third cycle. The same operations were repeated thereafter. A state of damage of the graphic of the decorative sheet for a road surface was observed visually every 10 cycles. A proportion of area of the damage by stationary steering out of area of the decorative sheet for a road surface being in contact with the tires was estimated. After 300 cycles, a case where the proportion of the area of the damage was less than 10% was evaluated as “good (A),” and a case where the proportion of the area of the damage was 10% or greater was evaluated as “poor (B).”

### Example 13

In this example, a decorative sheet for a road surface including the same configuration as in Example 1 was produced with the exception of production of a urethane resin and a retroreflective member. In this example, in the production of the urethane resin, a coating amount of a mixture was 310 g/m², and in the production of the retroreflective member, a dispersing amount of glass beads was 152 g/m². In addition, in this example, in contrast to Example 1, the decorative sheet for a road surface was installed on concrete having a size of 300 mm×300 mm×50 mm.

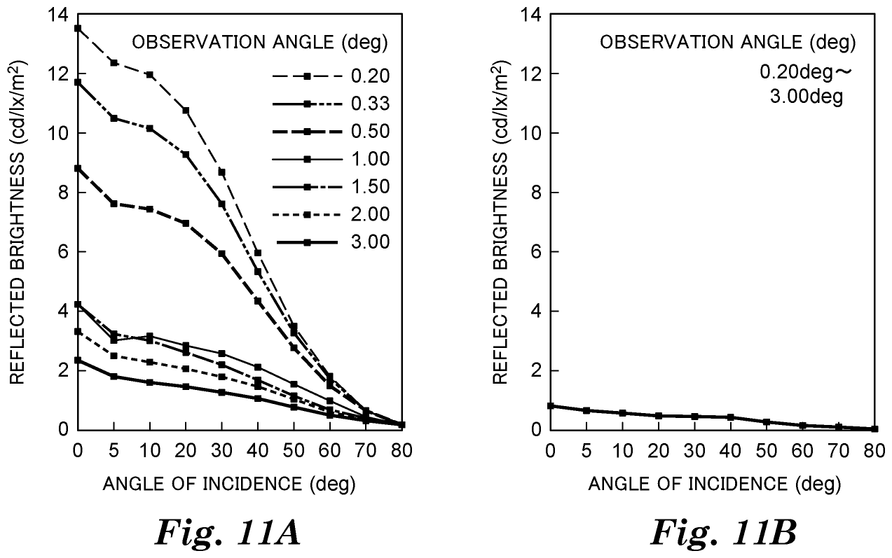

FIG. 11A shows results of measuring the retroreflectivity performance according to Example 12, and FIG. 11B shows results of measuring the retroreflectivity performance according to Example 13. In these figures, relationship between an angle of incidence (deg, degrees) and reflected brightness (cd/lx/m²) is shown, and an observation angle is varied from 0.20 (deg) to 3.00 (deg). In Example 12, the reflected brightness increased as the observation angle increased from 3.00 (deg) to 0.20 (deg). In Example 13, the reflected brightness was almost a constant value even when the observation angle increased from 3.00 (deg) to 0.20 (deg).

Table 8 shows the configurations and test results of the decorative sheets for a road surface according to Examples 12 and 13. In the graphical image observation and the retroreflectivity performance test, Examples 12 and 13 both achieved evaluation of “A,” and Example 12 was particularly excellent in both the graphical image observation and the retroreflectivity performance test.

TABLE 8

| | Example 12 | Example 13 |
|---|---|---|
| Surface coating layer urethane resin | ESG A agent | ESG A agent |
| | ESG B agent | ESG B agent |
| In surface coating layer | No | NB-153 |
| Retroreflective member | | |
| Retroreflective member in graphic | NB-153 | No |
| construct | | |
| Graphical image observation | A | A |
| Retroreflectivity performance test | A | A |
| Stationary steering test | A | A |

The decorative sheet for a road surface will be described further hereinafter in examples of the present invention and comparative examples. In Examples 14 to 17 and Comparative Example 6, materials shown in Tables 9 to 11 were used. Note that abbreviations in Table 9 mean the following compounds.

IOA: Isooctyl acrylate

AA: Acrylic acid

1,4-BDA: 1,4-butanediol diacrylate

TABLE 9

| | | | Solid | |
|---|---|---|---|---|
| | | | content | |
| Material | Component | Diluent | (%) | Available from |
| First solvent | Xylene | — | — | Mitsubishi |
| | | | | Chemical Co., |
| | | | | Ltd. |
| First additive | Triethylamine | — | — | Air Products |
| | | | | & Chemicals Co., |
| | | | | Ltd. |
| Second additive | Mineral oil (Nopco | — | — | San Nopco |
| | JMY) | | | |
| Third additive | Ammonia water | Water-based | 25 | Wako Pure |
| | | | | Chemical |
| | | | | Industries, Ltd. |
| First catalyst | p-Toluene sulfonic | Isopropyl | 40 | 3M |
| | acid | alcohol | | |
| First coating agent | Alkyd resin | Xylene | 66 | Hitachi Chemical |
| | (TL2055-66) | | | Company, Ltd. |
| Second coating | Melamine resin | Butanol/xylene | 67 | Hitachi Chemical |
| agent | (M11-HI) | | | Company, Ltd. |
| Acrylic beads | Acrylic resin (MZ- | — | — | Soken Chemical |
| | 20HN) | | | & Engineering |
| | Average particle | | | Co., Ltd. |
| | diameter: 20 μm | | | |
| Substrate film | PET film (G2-PET) | — | — | Teijin |
| | Thickness: 50 μm | | | |
| Primer | Isocyanate | Toluene | 0.3 | 3M |
| | compound | | | |
| Pressure-sensitive | Pressure-sensitive | Water-based | 35 | 3M |
| adhesive | adhesive acrylic | | | |
| microparticles | resin | | | |
| | Average particle | | | |
| | diameter: 37 μm | | | |
| First pressure- | Acrylic pressure- | Water-based | 54.5 | Soken Chemical |
| sensitive adhesive | sensitive adhesive | | | & Engineering |
| | (SK-Dyne) | | | Co., Ltd. |
| First curing agent | Epoxy compound | Toluene | 5 | Soken Chemical |
| | (E-AX) | | | & Engineering |
| | | | | Co., Ltd. |
| First film | Vinyl chloride film | — | — | 3M |
| | with pressure- | | | |
| | sensitive adhesive | | | |
| | (STR1002) | | | |
| Second film | Application tape | — | — | 3M |
| | made of paper | | | |
| | (SCPM-44X) | | | |
| Third film | Application tape | — | — | 3M |
| | made of | | | |
| | transparent plastic | | | |
| | film (HA-2L) | | | |

TABLE 10
Solution for producing first coating solution

| Material | Compounding ratio |
|---|---|
| First coating agent | 39.11 |
| Second coating agent | 13.97 |
| First additive | 0.14 |
| First catalyst | 0.11 |
| First solvent | 46.67 |

TABLE 11
Solution for producing second coating solution

| Material | Compounding ratio |
|---|---|
| Pressure-sensitive adhesive microparticles | 23.15 |
| First pressure-sensitive adhesive | 59.59 |
| First additive | 0.07 |
| Second additive | 0.99 |
| Purified water | 16.20 |

### Example 14

### Production of Backing Film Layer

First, a solution for producing a first coating solution was prepared. This solution includes the materials and the compounding ratios shown in Table 10. 50.02 g of the solution for producing a first coating solution and 8.77 g of acrylic beads were weighed, and were stirred for 5 minutes at 1000 rpm by using a Cowles mixer to adjust a first coating solution. A Homodisper model 2.5 (available from Primix Corporation) was used as the Cowles mixer.

Subsequently, a substrate film was prepared, and the first coating solution was applied onto a first face of this substrate film by a knife coating method. A coating amount of the first coating solution was 0.082 g per film area of 3 cm×15 cm of the substrate film in terms of dry weight. The substrate film to which the first coating solution was applied was heated and dried for 2 minutes at a temperature of 65° C., subsequently heated and dried for 1 minute at a temperature of 95° C., and further heated and dried for 3 minutes at a temperature of 155° C. to form an acrylic bead-containing coat layer on the first face of the substrate film.

Next, a primer was prepared, and the primer was applied onto a second face positioned on the opposite side to the first face of the substrate film by a knife coating method. The substrate film to which the primer was applied was heated and dried for 1 minute at a temperature of 65° C. to form a primer layer on the second face of the substrate film.

Next, a solution for producing a second coating solution was prepared. This solution includes the materials and the compounding ratios shown in Table 11. 40.08 g of the solution for producing a second coating solution, 9.19 g of purified water, and 1.94 g of a first curing agent were weighed, and were stirred for 5 minutes at 1000 rpm by using a Cowles mixer to adjust a second coating solution. A Homodisper model 2.5 (available from Primix Corporation) was used as the Cowles mixer.

Subsequently, the second coating solution was applied onto the primer layer by a knife coating method. A coating amount of the second coating solution was 0.048 g per area of 3 cm×15 cm of the primer layer in terms of dry weight. The substrate film in which the second coating solution was applied onto the primer layer was heated and dried for 2 minutes at a temperature of 65° C. and subsequently heated and dried for 3 minutes at a temperature of 95° C. to form a pressure-sensitive adhesive microparticle-containing acrylic pressure-sensitive adhesive layer on the primer layer. A backing film layer was complete as a result of the formation of the pressure-sensitive adhesive microparticle-containing acrylic pressure-sensitive adhesive layer on the primer layer. The backing film layer includes the acrylic bead-containing coat layer, the substrate film, the primer layer, and the pressure-sensitive adhesive microparticle-containing acrylic pressure-sensitive adhesive layer in this order.

### Production of Design Layer

A white acrylic ink absorbing layer was formed on aluminum foil to produce a design layer of a film shape. The white acrylic ink absorbing layer was produced by the same procedure as the procedure used in the production of the ink absorbing layer in Example 1.

### Production of Precursor for Graphic Construct

In this example, the pressure-sensitive adhesive microparticle-containing acrylic pressure-sensitive adhesive layer of the backing film and the aluminum foil of the design layer were attached to each other to produce a precursor for a graphic construct. This precursor includes the backing film layer and the design layer.

Table 12 is a table showing the configuration of the precursor for a graphic construct according to Example 14. In this table, a thickness or mass per unit area of each of layers present in the design layer and in the backing film layer is shown.

TABLE 12

| | | Thickness or mass | |
|---|---|---|---|
| | Configuration | per unit area | |
| Design layer | White acrylic ink absorbing layer | 80 | μm |
| | Aluminum foil | 50 | μm |
| Backing film | Pressure-sensitive adhesive | 11 | g/m² |
| layer | microparticle-containing acrylic | | |
| | pressure-sensitive adhesive layer | | |
| | Substrate film layer | 50 | μm |
| | Acrylic bead-containing coat layer | 18 | g/m² |

### Stiffness Test

The precursor for a graphic construct produced in Example 14 was cut to have a size of 1.5 inches (38.1 mm) in an MD direction and 1 inch (25.4 mm) in a CD direction to prepare a test piece. The MD direction (Machine Direction) refers to a direction in which the precursor for a graphic construct is wound (vertical direction), and the CD direction (Cross Machine Direction) refers to a direction perpendicular to the vertical direction (horizontal direction).

A stiffness S of the test piece was measured by using a Gurley stiffness tester (see TAPPI T 545 om-94). In the stiffness test, a distance D from a weight to a rotational axis of a pendulum was 4 inches (101.6 mm), mass M of the weight was 25 g, a length Lp of the test piece was 1 inch (25.4 mm), and a width Wp of the test piece was 1 inch (25.4 mm). In this example, a scale R of the pendulum was read, and the stiffness S was calculated by using Formula (1). The stiffness test was carried out three times, and the stiffness S was defined as an average value of the test results.

S=1000×(R×D×M×L_{R}²)/(10×V×W_{R}) (1)

In Formula (1), V represents a distance from a bar with which the test piece comes into contact to the pendulum, and is 127.0 mm in this example. L_{R} is a value (Lp/Ls) obtained by dividing the length Lp of the test piece by a reference length Ls of the test piece, and the reference length Ls of the test piece is 76.2 mm. W_{R} is a value (Wp/Ws) obtained by dividing the width Wp of the test piece by a reference width Ws of the test piece, and the reference width Ws of the test piece is 25.4 mm.

### Adhesive Strength Test in Standard State

An adhesive strength test of the backing film attached in a standard state (prior to heat-curing) with respect to the aluminum foil layer was performed. First, the precursor for a graphic construct produced in Example 14 was cut to have a size of 150 mm in the MD direction and 1 inch (25.4 mm) in the CD direction to prepare a test piece. Subsequently, the white acrylic ink absorbing layer side of each test piece was attached to an aluminum plate. A size of the aluminum plate was 150 mm×70 mm×1 mm (thickness), and the test piece was attached to the aluminum plate with a double-sided tape. Peel strength of the backing film with respect to the aluminum foil layer was investigated by using a tensile tester (available from Orientec). A peeling angle was 180 degrees, a measurement temperature was 20° C., and a peeling rate was 300 mm/min. A peeling test was performed twice, and the adhesive strength was calculated from an average value of the peel strength.

Adhesive Strength Test after Heat-Curing

An adhesive strength test of the backing film after heat-curing with respect to the aluminum foil layer was performed. In this test, a test piece attached to an aluminum plate was first prepared by the same procedure as the procedure used in the adhesive strength test in a standard state. Subsequently, this test piece was cured for 7 days at a temperature of 65° C., and after the test piece was further left to stand for 1 day at a temperature of 20° C., adhesive strength after heat-curing was calculated by the same procedure as the procedure used in the adhesive strength test in a standard state.

### Transportability Test

The precursor for a graphic construct was cut to have a size of 30 cm (width)×1 m (length) to prepare a test piece. Subsequently, a transportability test was performed by using a wide-format inkjet printer SOLJET PRO 4 XR640 (available from Roland DG). In this test, an end portion of a short side of the test piece was set in the printer, the test piece was transported by using a feed function, and changes in appearance of the test piece were observed visually. As a result of the visual test, a case where all of the following three points were satisfied was evaluated as “good (A)”: (i) the test piece maintains smoothness; (ii) there is no floating or folding from a platen of the printer; and (iii) no media jamming occurs. As a result of the visual observation, a case where any one of (i) to (iii) described above was not satisfied was evaluated as “poor (B).” Note that the platen refers to a printer site where the test piece is supported from behind in blowing ink, and the media jamming refers to a situation in which the test piece catches on a head configured to discharge ink, and a printing operation stops.

### Printability Test

The precursor for a graphic construct evaluated as “A” in the transportability test was cut to 30 cm (width)×1 m (length) to prepare a test piece. A printability test was carried out on the prepared test piece by using SOLJET PRO 4 XR640/ECO-SOL MAX2 ink (available from Roland DG). In the printability test, three types of digital images of a solid image, a CMYK color bar, and a photograph were printed. The solid image had ink concentrations of 67% cyan, 67% magenta, 67% yellow, and 100% black (total of 301%). A profile for printing used “IJ180Cv3-10,” which is a condition for Scotchcal (trade name) graphic film IJ180Cv3-10 (available from 3M). The printing conditions included standard image quality, a resolution of 720×720 dpi, bidirectional printing, and a Max concentration of Japan. In addition, temperature conditions were 40° C. with a pre-heater, 40° C. with a print heater, and 50° C. with an after-heater. In the printability test, the test piece for which printing was completed without issue was observed visually, and a case where good image quality was obtained was evaluated as “good (A).” A case where good image quality was not obtained was evaluated as “poor (B).” The test piece for which printing stopped at an intermediate stage was not observed visually and was evaluated as “poor (B).”

### Peelability Test

A peelability test of the design layer with respect to the backing film layer was performed. The peelability test was performed on the test piece evaluated as “A” in the printability test. Specifically, the test piece was placed on a workbench with the design layer of the test piece facing downward and with the backing film of the test piece facing upward, and the backing film was peeled from the test piece with a human hand. The design layer obtained after the backing film layer was peeled was observed visually, and a case where the film was flat with a little folding of the design layer was evaluated as “good (A).” On the other hand, a case where the film was not flat with much folding and crease of the design layer was evaluated as “poor (B).” Table 13 is a table showing the test results for Examples 14 to 17 and Comparative Example 6.

TABLE 13

| | | | | | Compar- |
|---|---|---|---|---|---|
| | | | | | ative |
| | Exam- | Exam- | Exam- | Exam- | Exam- |
| | ple 14 | ple 15 | ple 16 | ple 17 | ple 6 |
| Stiffness test [stiffness | 4.4 × | — | 1.1 × | 4.6 × | 3.2 × |
| (mgf)] | 10² | | 10³ | 10² | 10² |
| Transportability test | A | — | A | — | B |
| Adhesive strength in | 0.1 | 0.2 | 3.3 | 0.5 | — |
| standard state | | | | | |
| (N/25 mm) | | | | | |
| Adhesive strength after | 0.1 | 0.2 | 4.5 | 0.6 | — |
| heat-curing | | | | | |
| (N/25 mm) | | | | | |
| Printability test | A | — | A | — | — |
| Peelability test | A | A | B | B | — |

### Example 15

In Example 15, a film produced by the same procedure as in Example 14 was used as a design layer, and a first film was used as a backing film layer. A precursor for a graphic construct in this example includes a white vinyl chloride film, an acrylic pressure-sensitive adhesive layer, aluminum foil, and a white acrylic ink absorbing layer in this order. Table 14 is a table showing the configuration of the precursor for a graphic construct according to Example 15. In this table, a thickness of each of layers present in the design layer and in the backing film layer is shown.

TABLE 14

| | Configuration | Thickness |
|---|---|---|
| Design layer | White acrylic ink absorbing layer | 80 μm |
| | Aluminum foil | 50 μm |
| Backing film layer | Acrylic pressure-sensitive adhesive | 30 μm |
| (First film) | layer | |
| | White vinyl chloride film | 50 μm |

### Example 16

In Example 16, a film produced by the same procedure as in Example 14 was used as a design layer, and a second film was used as a backing film layer. A precursor for a graphic construct in Example 16 includes a paper layer, a pressure-sensitive adhesive layer, aluminum foil, and a white acrylic ink absorbing layer in this order. Table 15 shows the configuration of the precursor for a graphic construct according to Example 16 and a thickness of each layer of this precursor for a graphic construct.

TABLE 15

| | Configuration | Thickness |
|---|---|---|
| Design layer | White acrylic ink absorbing layer | 80 μm |
| | Aluminum foil | 50 μm |
| Backing film | Pressure-sensitive adhesive layer | Combination of |
| layer | Paper layer | two layers: 0.11 |
| (Second film) | | to 0.12 mm |

### Example 17

In Example 17, a film produced by the same procedure as in Example 14 was used as a design layer, and a third film was used as a backing film layer. A precursor for a graphic construct in Example 17 includes a transparent OPP film, an acrylic pressure-sensitive adhesive layer, aluminum foil, and a white acrylic ink absorbing layer in this order. Table 16 shows the configuration of the precursor for a graphic construct according to Example 17 and a thickness of each layer of this precursor for a graphic construct.

TABLE 16

| | Configuration | Thickness |
|---|---|---|
| Design layer | White acrylic ink absorbing layer | 80 μm |
| | Aluminum foil | 50 μm |
| Backing film layer | Acrylic pressure-sensitive adhesive | 25 μm |
| (Third film) | layer | |
| | Transparent OPP film | 50 μm |

### Comparative Example 6

In Comparative Example 6, a precursor for a graphic construct includes only a design layer. The design layer is produced by the same procedure as in Example 14. The precursor for a graphic construct in this comparative example includes aluminum foil and a white acrylic ink absorbing layer in this order. Table 17 shows the configuration of the precursor for a graphic construct according to Comparative Example 6 and a thickness of each layer of this precursor for a graphic construct.

TABLE 17

| | Configuration | Thickness |
|---|---|---|
| Design layer | White acrylic ink absorbing laver | 80 μm |
| | Aluminum foil | 50 μm |

### REFERENCE SIGNS LIST

1, 1p, 1q, 1r, is Decorative sheet for a road surface
5 Road surface
6 Road surface portion
10 Surface coating layer
11 Top end portion
12 Retroreflective member
14 Soda lime glass
16 Graphic construct
17A, 18A Particles (anti-skid member)
20 Design layer
22 Supporting layer
24 Ink absorbing layer
30 Adhesive layer
50 Precursor for a graphic construct
52 Backing film layer
54 Pre-design layer
54p Design layer
54a Supporting layer
54b Ink absorbing layer

1. A decorative sheet for a road surface comprising:
a graphic construct including an adhesive layer, and a design layer provided on the adhesive layer; and
a surface coating layer covering the graphic construct and containing a urethane resin.

2. The decorative sheet for a road surface according to claim 1, wherein the urethane resin contains a two-part urethane resin composition including a polyol as a main agent and a polyfunctional isocyanate as a curing agent.

3. The decorative sheet for a road surface according to claim 1 including an anti-skid member on the surface coating layer.

4. The decorative sheet for a road surface according to claim 1, wherein the design layer includes an ink absorbing layer and a supporting layer configured to support the ink absorbing layer; and
the ink absorbing layer is provided on the supporting layer.

5. The decorative sheet for a road surface according to claim 4, wherein the supporting layer includes aluminum foil.

6. The decorative sheet for a road surface according to claim 1, further including a retroreflective member on the surface coating layer.

7. The decorative sheet for a road surface according to claim 6, wherein the retroreflective member contains glass beads.

8. The decorative sheet for a road surface according to claim 1, wherein the design layer further includes an ink absorbing layer and a retroreflective layer; and
the retroreflective layer is disposed between the ink absorbing layer and the adhesive layer.

9. The decorative sheet for a road surface according to claim 8, wherein the retroreflective layer includes an intermediate resin layer containing a resin surrounding a retroreflective member, and a reflective vapor deposited layer covering the intermediate resin layer; and
the reflective vapor deposited layer is disposed between the intermediate resin layer and the adhesive layer.

10. The decorative sheet for a road surface according to claim 9, wherein the retroreflective member contains glass beads.

11. The decorative sheet for a road surface according to claim 8, wherein the design layer further includes a supporting layer configured to support the retroreflective layer and disposed between the retroreflective layer and the adhesive layer.

12. A precursor for a graphic construct comprising:
a pre-design layer including an ink absorbing layer and a supporting layer; and
a backing film layer including a substrate film layer and a pressure-sensitive adhesive layer;
wherein the backing film layer is peelably attached to the pre-design layer with the pressure-sensitive adhesive layer.

13. The precursor for a graphic construct according to claim 12, wherein the precursor has a stiffness exceeding 320 mgf; and
the pressure-sensitive adhesive layer has adhesive strength smaller than 0.5 N/25 mm.

14. A method of producing a graphic construct sheet comprising the steps of:
forming a design layer by using a precursor for a graphic construct including, in this order, at least an ink absorbing layer, a supporting layer, and a backing film layer including a pressure-sensitive adhesive layer to perform printing on the ink absorbing layer of the precursor; and
peeling the backing film layer from a printed precursor on which the design layer is formed.

15. A method of installing a decorative sheet for a road surface comprising the steps of:
installing a graphic construct including an adhesive layer and a design layer provided on the adhesive layer on a road surface; and
coating a surface of the graphic construct installed on the road surface with a urethane resin.

16. The method of installing a decorative sheet for a road surface according to claim 15, wherein a region coated with the urethane resin in the step of coating with the urethane resin includes a road surface portion exposed without being covered with the graphic construct around a perimeter of the graphic construct.
